(19) United States
(12) Patent Application Publication
(10) Pub. No.: US 2025/0320988 A1
(43) Pub. Date: Oct. 16, 2025

(54) ASSEMBLY FOR LIGHT MODULE EXTENSION AND ARTICULATION AND HOUSING THEREFOR

(71) Applicant: AMP Plus, Inc., Vernon, CA (US)

(72) Inventor: Brandon Cohen, Vernon, CA (US)

(73) Assignee: AMP Plus, Inc., Vernon, CA (US)

(21) Appl. No.: 19/247,643

(22) Filed: Jun. 24, 2025

Related U.S. Application Data
(63) Continuation-in-part of application No. 19/057,375, filed on Feb. 19, 2025.
(63) Continuation-in-part of application No. 19/020,672, filed on Jan. 14, 2025.
(63) Continuation-in-part of application No. 29/894,010, filed on Jun. 5, 2023.
(63) Continuation-in-part of application No. 29/962,228, filed on Sep. 10, 2024.
(63) Continuation-in-part of application No. 29/981,337, filed on Dec. 30, 2024.

(51) Int. Cl. F21V 21/14; F21S 8/02; F21V 21/04

(52) U.S. Cl. CPC F21V 21/14; F21S 8/026; F21V 21/04

(57) ABSTRACT

A pull-down-assembly is usable in lighting applications. A can of the pull-down-assembly may hold a lighting-module that is configured to emit light. The can, of the pull-down-assembly, is extendable downwards in a linear fashion from a bracket, of the pull-down-assembly, via a linear-extension-subassembly of the pull-down-assembly. A linkage-arm, of the linear-extension-subassembly, permits the can to also be rotated. The bracket is attachable to a structure that is separate and external to the pull-down-assembly, such as, but not limited to, a housing (enclosure), a hangar-bar, a joist and/or a stud. The pull-down-assembly permits the can (and its lighting-module) to be extended downwards into an extended configuration and/or rotated or pushed back upwards into a retracted configuration.

### PRIORITY NOTICE

The present application, a continuation-in-part (CIP) application, claims priority under 35 U.S.C. § 120 to U.S. Non-Provisional patent application Ser. No. 19/057,375 filed on Feb. 19, 2025, the disclosure of which is incorporated herein by reference in its entirety. The present application, a continuation-in-part (CIP) application, claims priority under 35 U.S.C. § 120 to U.S. Non-Provisional patent application Ser. No. 19/020,672 filed on Jan. 14, 2025, the disclosure of which is incorporated herein by reference in its entirety. The present application, a continuation-in-part (CIP) application, claims priority under 35 U.S.C. § 120 to U.S. Non-Provisional patent application Ser. No. 29/894,010 filed on Jun. 5, 2023, the disclosure of which is incorporated herein by reference in its entirety. The present application, a continuation-in-part (CIP) application, claims priority under 35 U.S.C. § 120 to U.S. Non-Provisional patent application Ser. No. 29/962,228 filed on Sep. 10, 2024, the disclosure of which is incorporated herein by reference in its entirety. The present application, a continuation-in-part (CIP) application, claims priority under 35 U.S.C. § 120 to U.S. Non-Provisional patent application Ser. No. 29/981,337 filed on Dec. 30, 2024, the disclosure of which is incorporated herein by reference in its entirety.

### CROSS REFERENCE TO RELATED PATENTS

The disclosures and teachings of the following U.S. patents, by the same inventor as the present patent application are all incorporated by reference as if fully set forth herein: D935082; 10914465; 11092326; 11300259; 11466849; 11668458; 11649954; and 12066175.

### TECHNICAL FIELD OF THE INVENTION

The present invention relates in general to cans for lighting fixtures (lighting modules) and more specifically to lighting assemblies that are configured to permit the cans (with or without lighting fixtures [lighting modules]) to be pulled downwards (e.g., from a ceiling) into an extended configuration or pushed back up into the ceiling, above the ceiling, in a retracted configuration.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Circa 2025, recessed ceiling lighting where the light source, light fixture, and/or light module resides at least mostly above a ceiling are common place, both in residential, business, commercial, and industrial use applications.

However, with respect to a given light fixture (and/or light module) installed above a ceiling, there may be lighting use applications where it may be desirable to pull down the light emitting portion (of that given light fixture and/or light module), by at least some finite and/or fixed distance (e.g., from a bottom of that ceiling), and when extended such, to be able to rotate that light emitting portion to direct the emitted light into a different direction and/or different focal area as compared to when that light emitting portion may be residing above that ceiling.

There is a need in the art for a lighting pull-down-assembly that may be installed above a ceiling, but may be capable of having a portion (with the light emitting portion) extendable below that ceiling and rotatable and also capable of being pushed back up into its retracted configuration above the ceiling. Additionally, there is a need for a housing (enclosure) that is configured to house such at least one such lighting pull-down-assembly.

It is to these ends that the present invention has been developed.

### BRIEF SUMMARY OF THE INVENTION

To minimize the limitations in the prior art, and to minimize other limitations that will be apparent upon reading and understanding the present specification, the present invention describes embodiments of pull-down-assemblies and housings (enclosures) for such pull-down-assemblies, wherein a given pull-down-assembly may house a lighting-module (light fixture). A pull-down-assembly is usable in various lighting applications. A can of the pull-down-assembly may hold a lighting-module that is configured to emit light. The can, of the pull-down-assembly, is extendable downwards in a linear fashion from a bracket, of the pull-down-assembly, via a linear-extension-subassembly of the pull-down-assembly. A linkage-arm, of the linear-extension-subassembly, permits the can to also be rotated. The bracket is attachable to a structure that is separate and external to the pull-down-assembly, such as, but not limited to, a housing (enclosure), a hangar-bar, a joist and/or a stud. The structure that is separate and external to the pull-down-assembly may be located above a given ceiling. The pull-down-assembly permits the can (and its lighting-module) to be extended downwards into an extended configuration and/or rotated or pushed back upwards into a retracted configuration.

In some embodiments, a given pull-down-assembly may be used in various lighting applications. In some embodiments, at least one pull-down-assembly and/or a housing therefor may be installed within and/or above a ceiling. In some embodiments, at least one pull-down-assembly and/or a housing therefor may be installed above: ceiling drywall, ceiling sheeting, ceiling sheathing, ceiling members, ceiling tiles, ceiling boards, a false ceiling, a drop-down ceiling, and/or the like. In some embodiments, when at least one pull-down-assembly and/or a housing therefor may be installed above a ceiling, the can(s) (of the pull-down-assemblies) may be extended (pulled) below a bottom plane/surface of that ceiling (e.g., into an extended configuration) or pushed back up to be above that bottom plane/surface of that ceiling (e.g., into a retracted configuration). Further, when in the extended configuration, those extended can(s) (of the pull-down-assemblies) may also be rotated (e.g., ninety [90] degrees or less). Thus, a user may adjust where light shines from out of the bottom(s) of such can(s) (of the pull-down-assemblies).

In some embodiments, a given pull-down-assembly may comprise: a bracket, at least one linear-extension-subassembly, and a can. In some embodiments, the can may be configured to house (enclose, hold, and/or retain) at least most of at least one lighting-module (within that can). In some embodiments, the given pull-down-assembly may comprise at least one lighting-module. In some embodiments, the at least one lighting-module may be at least mostly disposed within the can of the given pull-down-assembly. In some embodiments, the given pull-down-assembly may comprise (at least one) trim. In some embodiments, the trim may be attached and/or located to/at a bottom of the can of the given pull-down-assembly. In some embodiments, the trim may be located at a bottom of the given pull-down-assembly. In some embodiments, the trim may be located under a bottom of the can of the given pull-down-assembly, forming a bottom of that given pull-down-assembly.

In some embodiments, the linear-extension-subassembly (of the given pull-down-assembly) may provide the ability for the can (of the given pull-down-assembly) to move in a straight linear pull-down or push-up movement, with respect to the can (of the given pull-down-assembly), such that the can may move from a fully retracted configuration into a fully extended configuration. The range of motion from the fully retracted configuration to the fully extended configuration may comprise a plurality of stop locations, such that the can may be positioned at various stopping points up to its fully extended configuration. Each such stopping point may involve (temporary) physical engagement between a terminal end that is rounded and a complementary recessed-shaped, similar to a ball-socket joint, but where the ball and the socket are only hemispherical. A plurality of possible hemispherical ball and socket like interactions are retained within the given linear-extension-subassembly (of the given pull-down-assembly). There may be one to three such hemispherical ball members with a plurality of complementary hemispherical recessed socket like regions per each linear-extension-subassembly. The hemispherical ball member(s) may slide up or down against the plurality of complementary hemispherical recessed socket like regions. And when a given hemispherical ball member comes into contact with one hemispherical recessed socket like region (selected from the plurality of complementary hemispherical recessed socket like regions), the can may be encouraged or may tend to stop or come to a stop.

It is an objective of the present invention to provide an assembly that is configured to house, enclose, hold, and/or retain a lighting-module (or lighting-fixture).

It is another objective of the present invention where that assembly (with or without a lighting-module [lighting-fixture]) is configured to be installed above a ceiling.

It is another objective of the present invention where that assembly (with or without a lighting-module [lighting-fixture]) is configured to be installed above a ceiling to structure above that ceiling.

It is another objective of the present invention where that structure above the ceiling may be a housing (enclosure), hangar-bar(s), joist(s), and/or stud(s).

It is another objective of the present invention where that housing (enclosure) (that may be installed above the ceiling) is configured to house, enclose, hold, and/or retain at least one of the assemblies (such as, but not limited to, a pull-down-assembly).

It is another objective of the present invention where that housing (enclosure) may comprise multiple locations for attachment of at least one pull-down-assembly, such that the at least one pull-down-assembly may be installed within the housing (enclosure) in multiple rotational orientations.

It is another objective of the present invention where that housing (enclosure) may comprise hangar-bar(s) and/or a junction-box.

It is another objective of the present invention where that assembly (with or without a lighting-module [lighting-fixture]) is a pull-down-assembly; wherein the pull-down-assembly is configured to permit a can (of the pull-down-assembly) to be pulled-down into an extended configuration or pushed up into a retracted configuration.

It is another objective of the present invention where that pull-down-assembly may also permit that can to be rotated.

It is yet another objective of the present invention where force imparted to the pull-down-assembly for movement of the can (e.g., extension movement, retraction movement, and/or rotational movement), may be supplied by a human and where that human may not be using nor holding any tools.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A depicts a pull-down-assembly (according to at least one embodiment), shown from a bottom right perspective view, and in a retracted (non-extended) configuration.

FIG. 1B depicts the pull-down-assembly of FIG. 1A, but now shown from a top right perspective view, and in its retracted (non-extended) configuration.

FIG. 1C depicts the pull-down-assembly of FIG. 1A, but now shown from a front view, and in its retracted (non-extended) configuration.

FIG. 1D depicts the pull-down-assembly of FIG. 1A, but now shown from a rear view, and in its retracted (non-extended) configuration.

FIG. 1E depicts the pull-down-assembly of FIG. 1A, but now shown from a top view, and in its retracted (non-extended) configuration.

FIG. 1F depicts the pull-down-assembly of FIG. 1A, but now shown from a bottom view, and in its retracted (non-extended) configuration.

FIG. 1G depicts the pull-down-assembly of FIG. 1A, but now shown from a right-side view, and in its retracted (non-extended) configuration.

FIG. 1H depicts the pull-down-assembly of FIG. 1A, but now shown from a left-side view, and in its retracted (non-extended) configuration.

FIG. 2A depicts the pull-down-assembly of FIG. 1A, but now shown from a bottom right perspective and exploded view.

FIG. 2B depicts the pull-down-assembly of FIG. 1A, but now shown from a front exploded view.

FIG. 3A depicts the pull-down-assembly of FIG. 1A, but now shown from a bottom right perspective view, and in an extended (non-retracted) configuration.

FIG. 3B depicts the pull-down-assembly of FIG. 1A, but now shown from a top right perspective view, and in the extended (non-retracted) configuration.

FIG. 3C depicts the pull-down-assembly of FIG. 1A, but now shown from a rear view, and in the extended (non-retracted) configuration.

FIG. 3D depicts the pull-down-assembly of FIG. 1A, but now shown from a front view, and in the extended (non-retracted) configuration.

FIG. 3E depicts the pull-down-assembly of FIG. 1A, but now shown from a right-side view, and in the extended (non-retracted) configuration; as well as, in a rotated configuration.

FIG. 3F depicts the pull-down-assembly of FIG. 1A, but now shown from a bottom view, and in the extended (non-retracted) configuration.

FIG. 3G depicts the pull-down-assembly of FIG. 1A, but now shown from a top view, and in the extended (non-retracted) configuration.

FIG. 4A shows two separate and distinct pull-down-assemblies mounted within a housing (enclosure), shown from a bottom (right) perspective view; and wherein the pull-down-assemblies that are mounted within that housing are in their retracted (non-extended) configuration.

FIG. 4B shows the housing from FIG. 4A, but now shown from a top perspective view.

FIG. 4C shows the housing from FIG. 4A, but now shown from a bottom view.

FIG. 4D shows the housing from FIG. 4A, but now shown from a top view.

FIG. 4E shows the housing from FIG. 4A, but now shown from a right-side view.

FIG. 4F shows the housing from FIG. 4A, but now shown from a front view.

FIG. 5A shows two separate and distinct pull-down-assemblies mounted within the housing from FIG. 4A, shown from a bottom (right) perspective view; and wherein the pull-down-assemblies that are mounted within that housing are in their extended (non-retracted) configuration (and rotated configuration).

FIG. 5B shows the housing from FIG. 5A, but now shown from a top perspective view.

FIG. 5C shows the housing from FIG. 5A, but now shown from a bottom view.

FIG. 5D shows the housing from FIG. 5A, but now shown from a right-side view.

FIG. 5E shows the housing from FIG. 5A, but now shown from a front view.

FIG. 6 shows the housing from FIG. 4A and/or from FIG. 5A, but without any pull-down-assemblies mounted therein, and shown from a bottom view.

FIG. 7 shows a perspective exploded view of the housing from FIG. 4A and/or from FIG. 5A, but without including any pull-down-assemblies.

FIG. 8 shows a housing (enclosure) with two separate and distinct pull-down-assemblies mounted within that housing, shown from a bottom perspective view; and wherein the pull-down-assemblies that are mounted within that housing are in their retracted (non-extended) configuration.

FIG. 9 shows the housing from FIG. 8, but without including any pull-down-assemblies, shown from a bottom perspective view.

FIG. 10 shows a close up (detail) view of a region of FIG. 2A that shows exploded perspective details of one (1) linear-extension-subassembly of a given pull-down-assembly.

FIG. 11 shows a cross-sectional view of a pull-down-assembly in its retracted configuration with respect to being installed above a ceiling.

FIG. 12 shows a cross-sectional view of a pull-down-assembly in its extended configuration with respect to being installed above a ceiling.

### REFERENCE NUMERAL SCHEDULE

100 pull-down-assembly 100
101 bracket 101
102 tab 102
103 attachment-structure 103
105 aperture 105
107 fastener 107
109 linear-extension-subassembly 109
111 outer-cover 111
113 inner-cover 113
115 fastener 115
117 descendable-ascendable-subassembly 117
119 first-member 119
121 second-member 121
123 can 123
125 trim 125
127 reflector 127
129 wiring/cabling 129
131 top 131
133 bottom 133
135 opening 135
200 integrated-lighting-module 200
201 electrical-connector 201
203 string-of-recessed-portions 203
205 recessed-portion-engager (raised-bump) 205
209 string-of-recessed-portions 209
211 slot 211
213 linkage-arm 213
215 recessed-portion-engager (raised-bump) 215
217 lip (flange edge protrusion) 217
219 fastener 219
221 channel 221
223 bolt 223
225 aperture 225
227 nut 227
229 plate 229
231 fastener 231
233 grommet (gasket) 233
300 arrow-indicating-downards-or-upwards-linear-movement 300
350 curved-arrow-indicating-rotational-movement 350
400 lighting housing (enclosure) 400
401 bottom-main-opening 401
403 sidewall(s) 403
405 top-panel 405
407 aperture(s) 407
409 plurality-of-apertures 409
411 junction-box 411
413 hangar-bar(s) 413
415 means-for-attaching-hangar-bar-to-sidewall 415
800 housing 800
801 bracket 801
803 slot(s) 803
805 clamp(s) 805
1101 ceiling 1101
1103 below-ceiling 1103
1105 above-ceiling 1105
1107 structure 1107
1109 hole/opening 1109

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

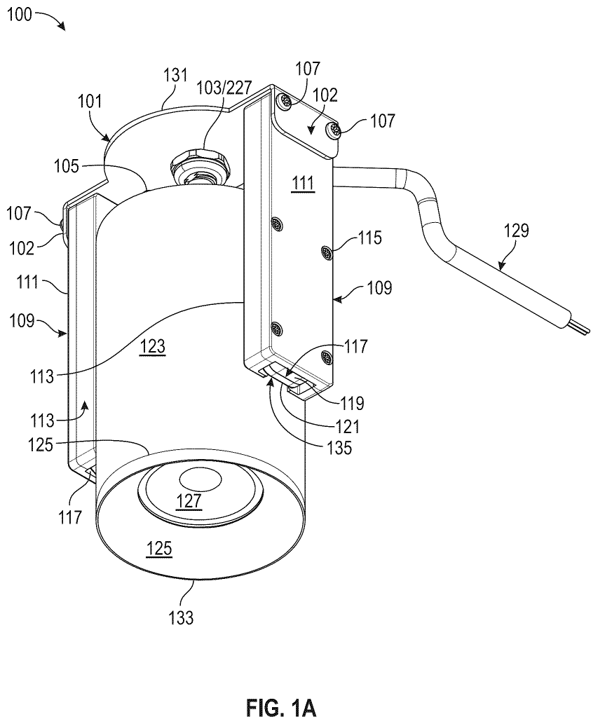

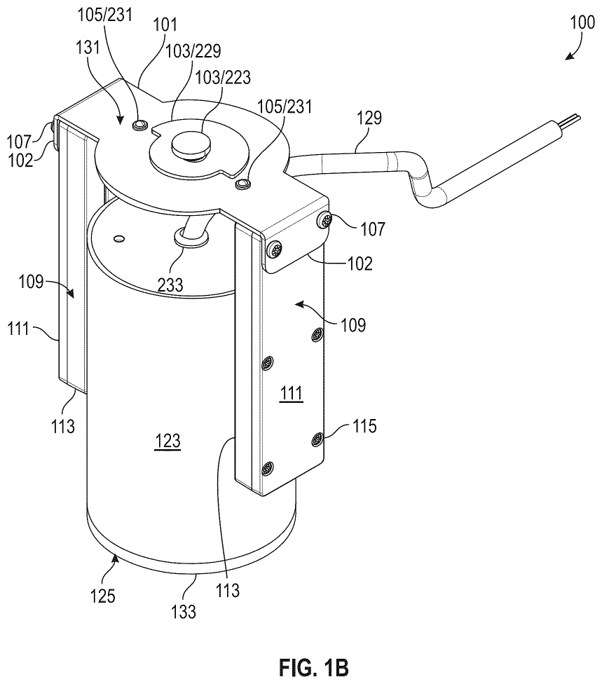

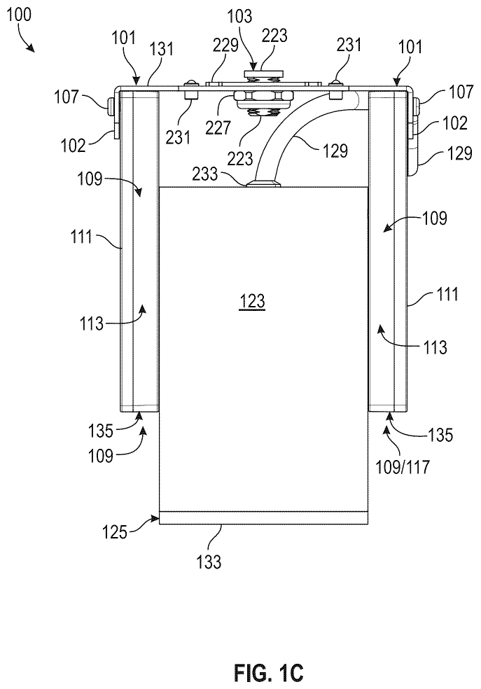

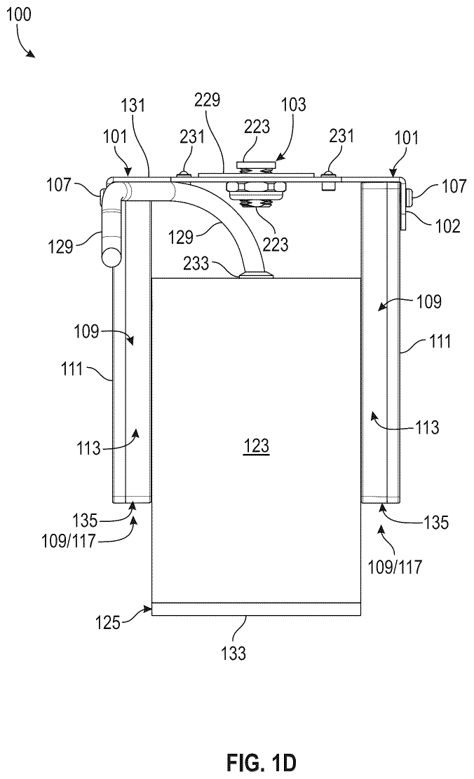

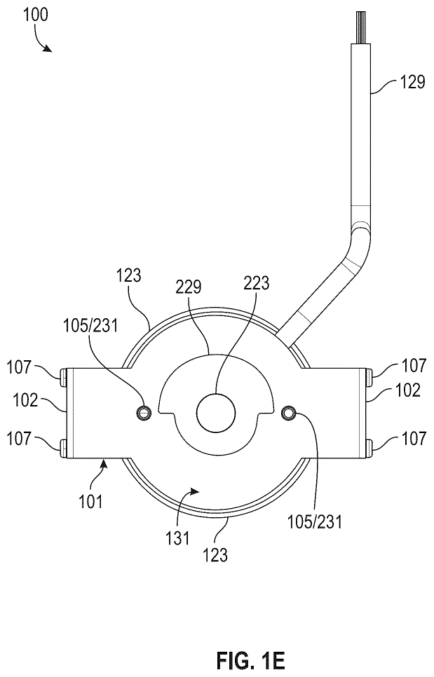

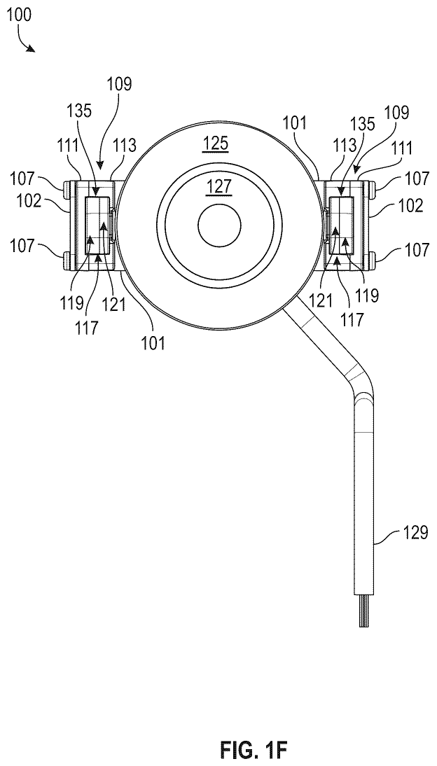

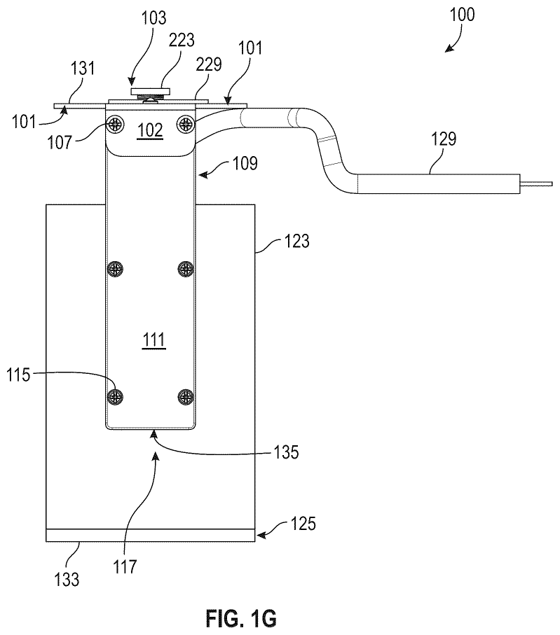

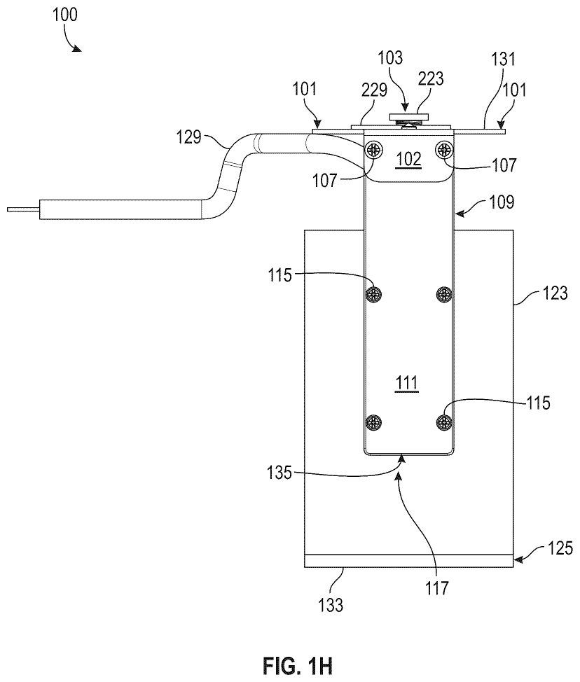

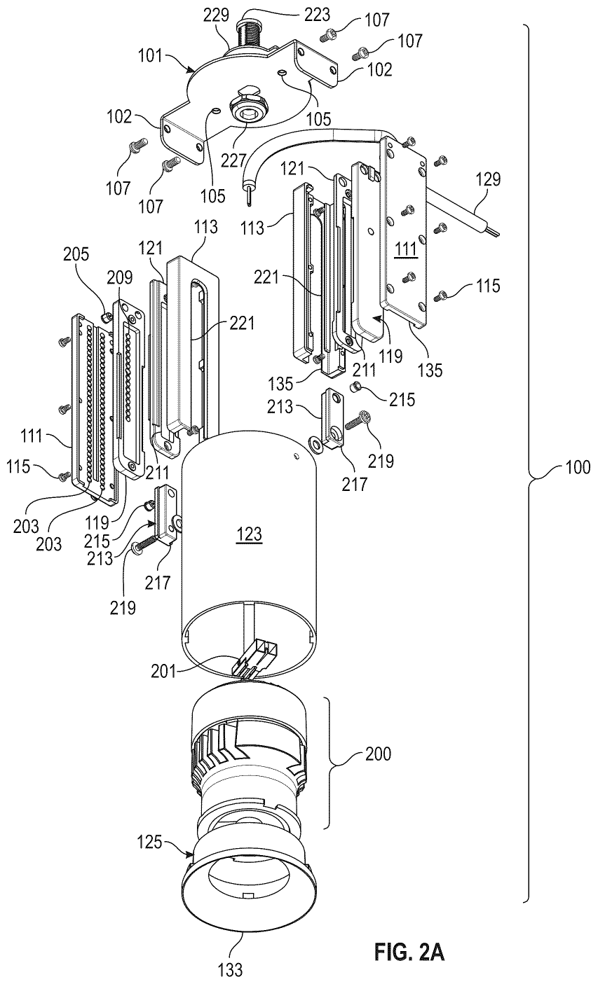

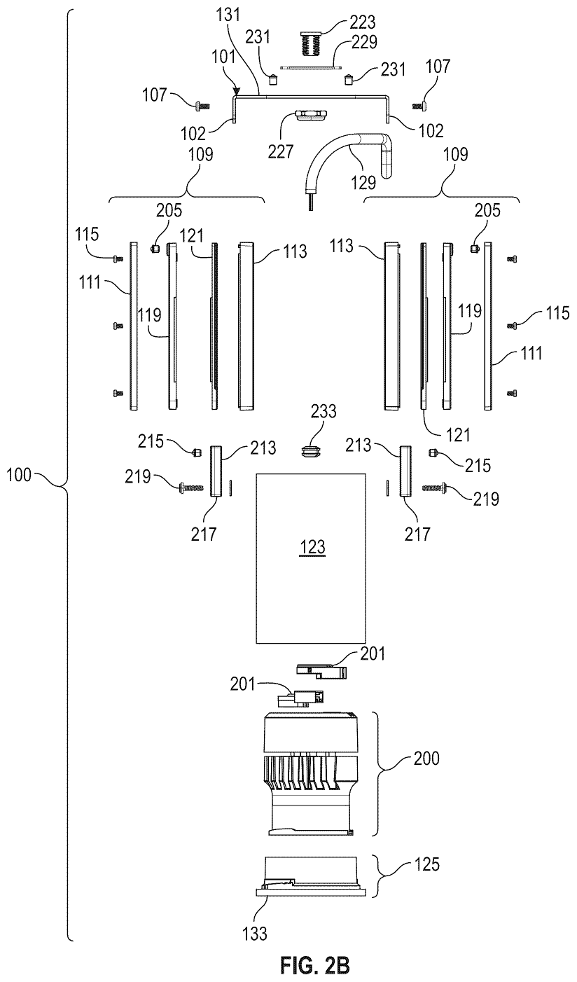

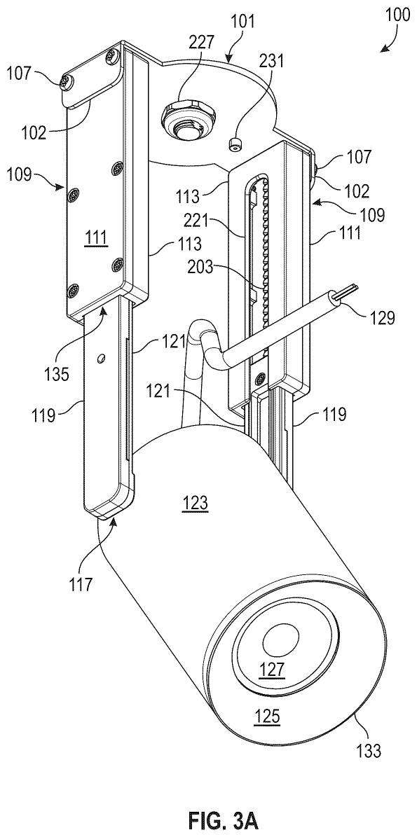

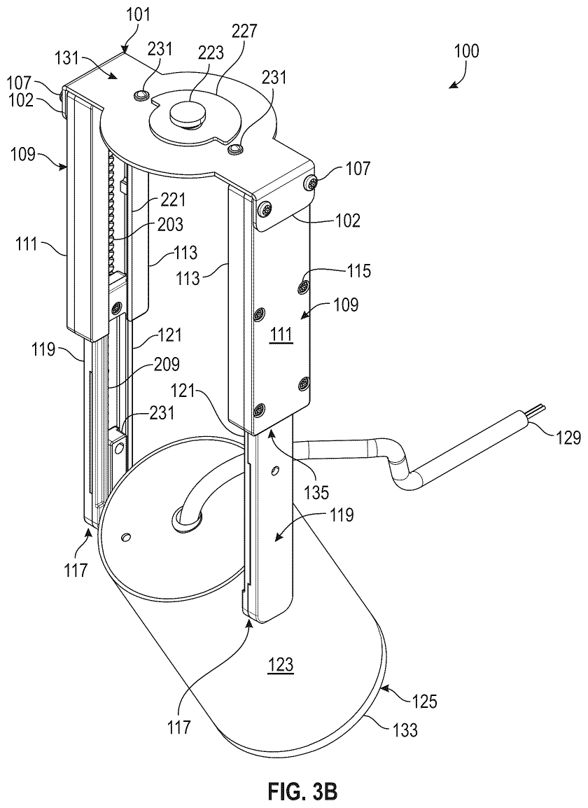

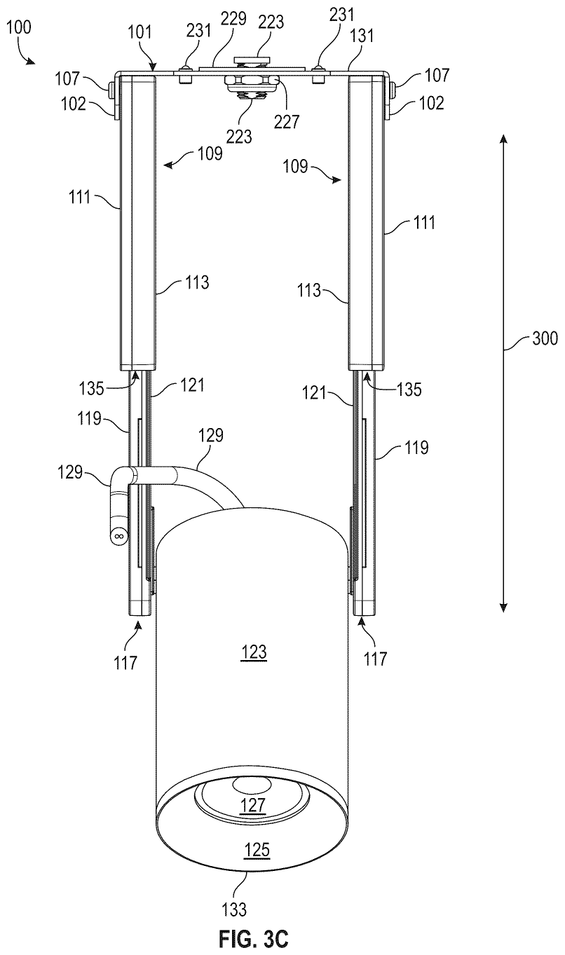

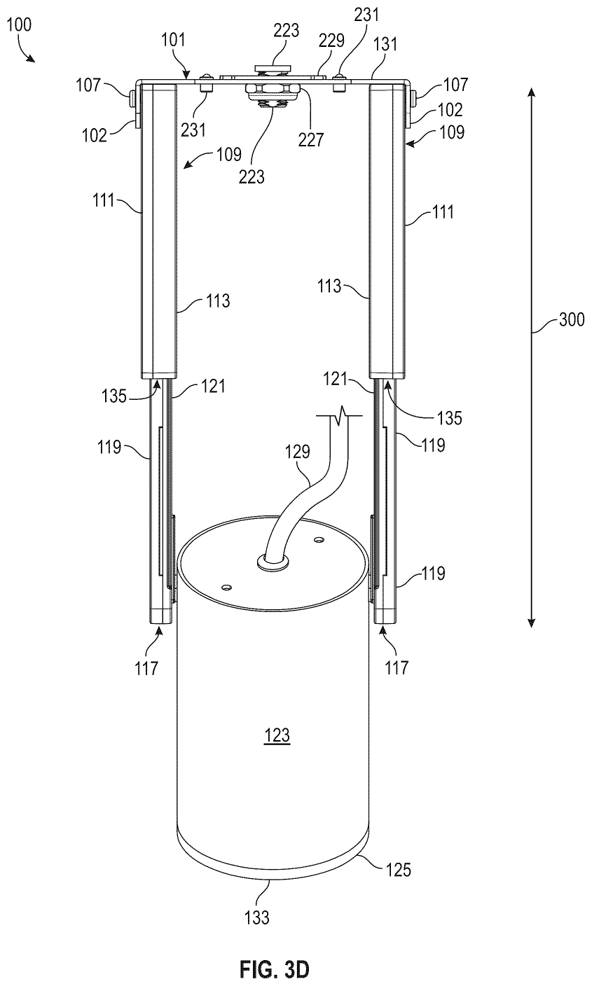

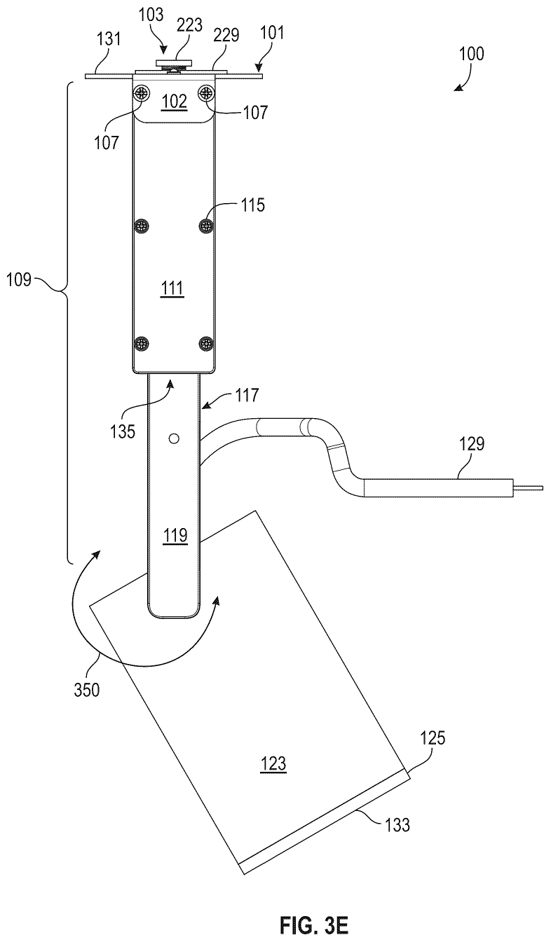

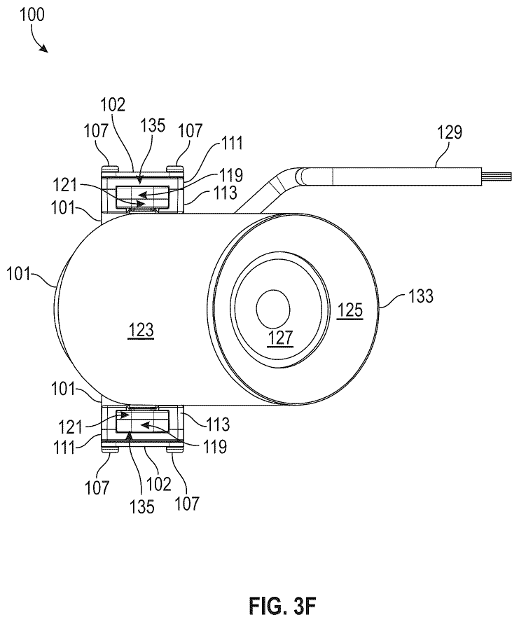

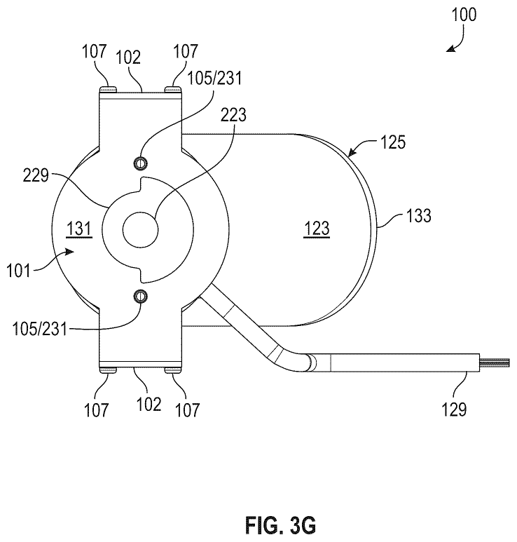

FIG. 1A depicts a pull-down-assembly 100 (according to at least one embodiment), shown from a bottom right perspective view, and in a retracted (non-extended) configuration. In some embodiments, housed within a can 123 of the pull-down-assembly 100, may be at least one integrated-lighting-module 200 (see e.g., FIG. 2A). Note, a portion of integrated-lighting-module 200 is shown in FIG. 1A, i.e., a portion of reflector 127 of integrated-lighting-module 200. Compare FIG. 1A to FIG. 3A, wherein FIG. 3A may show this same pull-down-assembly 100 but in its extended configuration.

Continuing discussing FIG. 1A, in some embodiments, pull-down-assembly 100 may comprise: at least one bracket 101, at least one linear-extension-subassembly 109, at least one can 123, and at least one integrated-lighting-module 200. In some embodiments, pull-down-assembly 100 may comprise: at least one bracket 101, at least one linear-extension-subassembly 109, at least one can 123, and at least one integrated-lighting-module 200, and at least one trim 125. In some embodiments, pull-down-assembly 100 may comprise: at least one bracket 101, at least one linear-extension-subassembly 109, and at least one can 123. In some embodiments, pull-down-assembly 100 may comprise: at least one bracket 101 and at least one linear-extension-subassembly 109. In some embodiments, pull-down-assembly 100 may also comprise at least one wire 129 (cable 129). In some embodiments, at least one linear-extension-subassembly 109 may be at least two separate (distinct) linear-extension-subassemblies 109.

Continuing discussing FIG. 1A, in some embodiments, linear-extension-subassembly 109 may be attached to (mounted to, secured to, affixed to,) bracket 101. In some embodiments, attachments between bracket 101 and linear-extension-subassembly 109 may be accomplished with at least one fastener 107 (such as, but not limited to, a screw, a bolt, or a pin). In some embodiments, a movable portion of linear-extension-subassembly 109 may be attached to can 123 (e.g., using fastener(s) 219). In some embodiments, trim 125 may be fitted into a bottom of can 123. In some embodiments, when trim 125 is assembled as part of pull-down-assembly 100 as shown in FIG. 1A, trim 125 may help to retain integrated-lighting-module 200 within can 123. In some embodiments, trim 125 may be attached to a bottom of can 123 (such as, but not limited to, teachings and disclosures of U.S. utility patent Ser. No. 11/649,954 that is incorporated herein as if fully set forth herein). In some embodiments, trim 125 may be attached to a bottom of integrated-lighting-module 200 (e.g., to its holder and/or its reflector 127). Note, see U.S. utility patent Ser. Nos. 10/914,465, 11/092,326, 11/466,849, and/or 11/668,458 for descriptions of integrated-lighting-module 200 and its components, such as, but not limited to, its holder (note, in those patents reference numeral “100” may be used for at least some of the integrated-lighting-modules shown and described). The teachings and disclosures of U.S. utility patent Ser. Nos. 10/914,465, 11/092,326, 11/466,849, and 11/668,458 are incorporated herein as if fully set forth herein. Also note, “integrated-lighting-module 200” and “lighting-module 200” may be used interchangeably herein; and lighting-module may be interchanged with lighting-fixture herein.

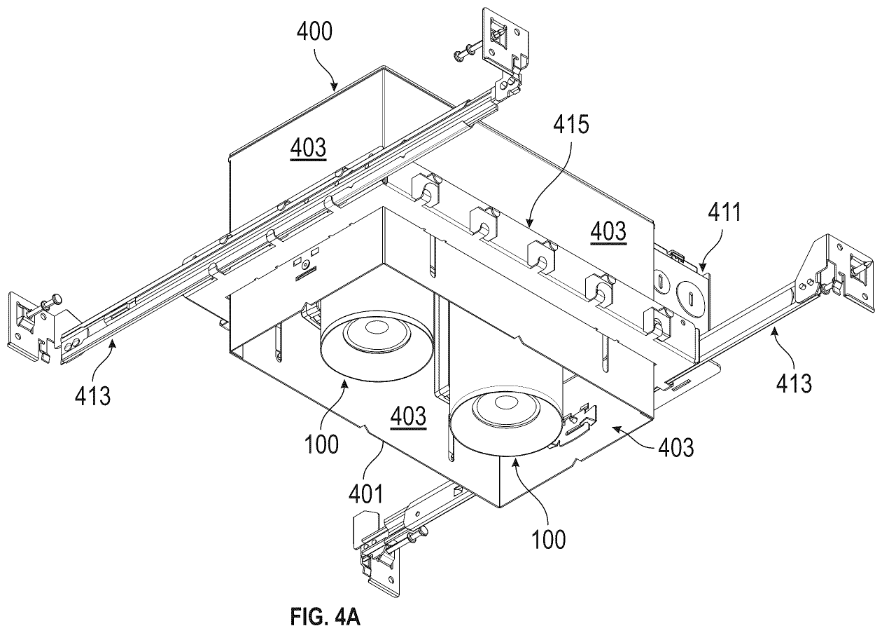

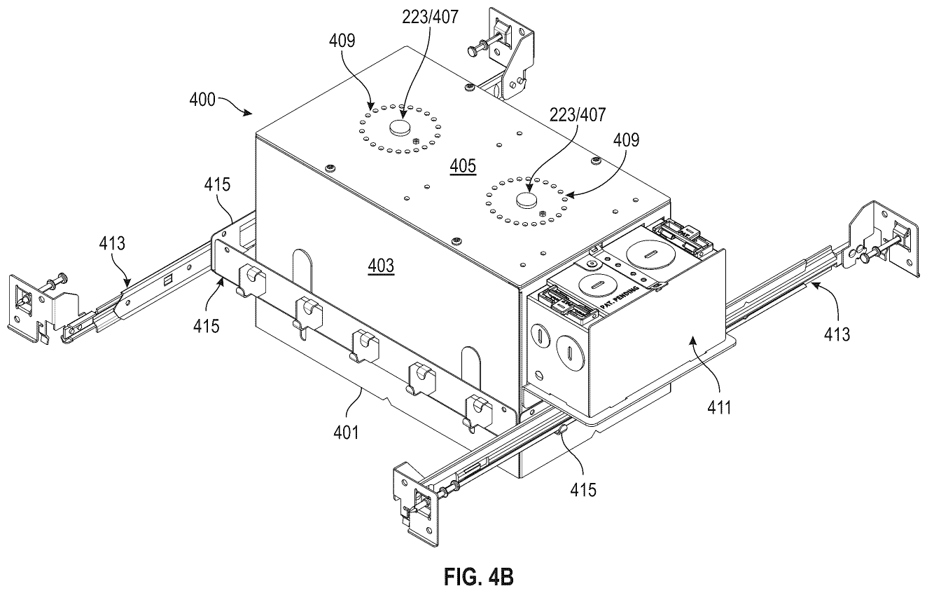

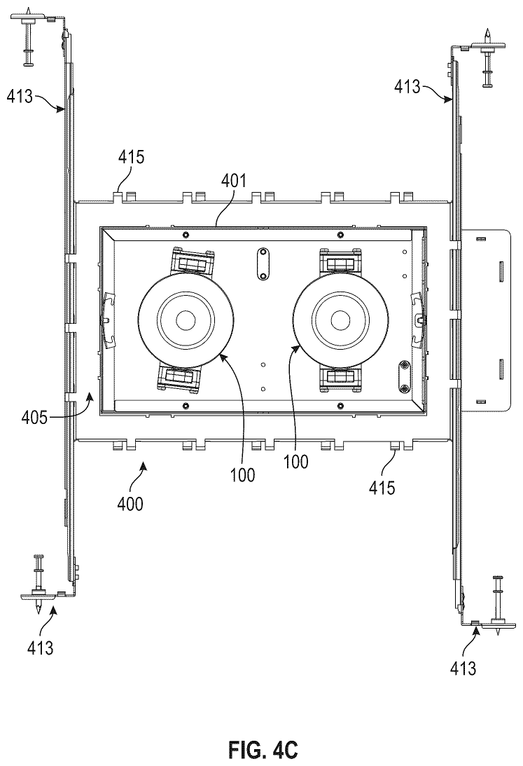

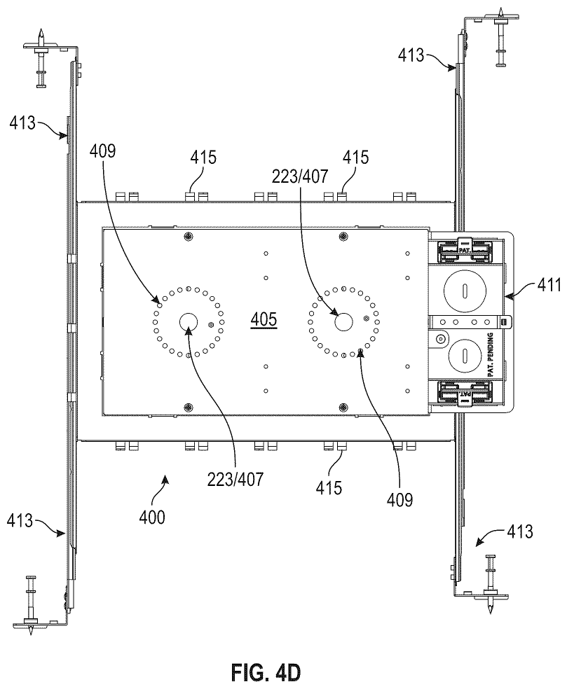

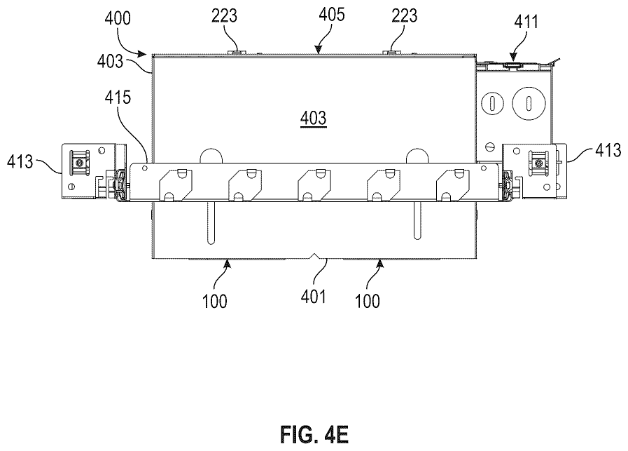

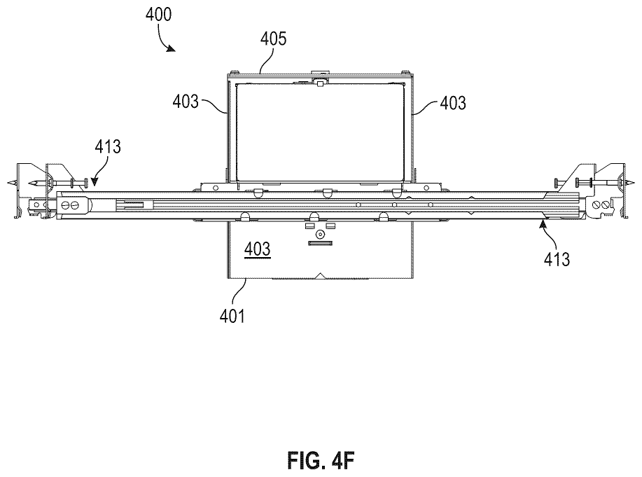

Continuing discussing FIG. 1A, in some embodiments, bracket 101 may be rigid member that has a mostly (substantially and/or largely) flat planar structure of uniform and fixed thickness, but that bends downwards at opposing ends, to form downward facing tabs 102. In some embodiments, a given tab 102 may have at least one through aperture (hole) that is configured for receiving a fastener, such as, but not limited to, fastener 107. In some embodiments, when bracket 101 is viewed from above (or below), a largest region of bracket 101 may be circular, with a diameter that may be about a same diameter as the outside diameter of can 123. In some embodiments, a top center of bracket 101 may comprise one or more attachment-structure(s) 103, such as, but not limited to, a largest-center-hole, a bolt configured for that largest-center-hole, a nut configured for that bolt, and/or a plate. In some embodiments, proximate (or adjacent) to attachment-structure(s) 103 (e.g., within two inches), bracket 101 may comprise at least one aperture 105. In some embodiments, aperture 105 may be a through hole, that extends entirely through a thickness of bracket 101. In some embodiments, attachment-structure(s) 103 and/or aperture 105 may be used to attach bracket 101 (and thus pull-down-assembly 100) to a structure located above pull-down-assembly 100 (see e.g., FIG. 4A and FIG. 4B). In some embodiments, the structure located above pull-down-assembly 100, that pull-down-assembly 100 may be attached to and below, may be a joist, a stud, a hangar-bar, and/or housing 400 (and/or housing 800). In some embodiments, bracket 101 may be made mostly from a metal and/or an alloy, such as, but not limited to, aluminum, steel, iron, and/or the like.

Continuing discussing FIG. 1A, in some embodiments, pull-down-assembly 100 may comprise at least one linear-extension-subassembly 109 or at least two linear-extension-subassembly 109. In some embodiments, using fastener(s) 107, an upper region of linear-extension-subassembly 109 may be attached to a tab 102 of bracket 101. In some embodiments, with respect to an assembled pull-down-assembly 100, each tab 102 may be attached to an upper region of linear-extension-subassembly 109 (e.g., using fastener(s) 107). In some embodiments, linear-extension-subassembly 109 may be how can 123 (with integrated-lighting-module 200) is downwards extendable away from bracket 101 as shown in FIG. 3A. Continuing discussing FIG. 1A, in some embodiments, portion(s) of linear-extension-subassembly 109 may also be how can 123 (with integrated-lighting-module 200) is rotatable with respect to certain portions of linear-extension-subassembly 109 (e.g., as shown in FIG. 3A).

Continuing discussing FIG. 1A, in some embodiments, a given linear-extension-subassembly 109 may comprise: a cover 111/113, an outer-cover 111, an inner-cover 113, and a descendable-ascendable-subassembly 117. In some embodiments, outer-cover 111 and inner-cover 113 may form a housing (enclosure), designated cover 111/113, that at least mostly (substantially) covers over (encloses) descendable-ascendable-subassembly 117 that is located within outer-cover 111 and inner-cover 113 (when descendable-ascendable-subassembly 117 is in its retracted configuration). In some embodiments, cover 111/113, an may comprise outer-cover 111 and inner-cover 113. Use of “cover 111/113” herein may refer to when a given outer-cover 111 is assembled to a given inner-cover 113. In some embodiments, when can 123 (with integrated-lighting-module 200) may be extended (e.g., as shown in FIG. 3A), outer-cover 111 and inner-cover 113 remain fixed and motionless with respect to bracket 101. Continuing discussing FIG. 1A, in some embodiments, outer-cover 111 may be attached to inner-cover 113 using fastener(s), such as, but not limited to, fastener(s) 115. In some embodiments, using fastener(s) 107, an upper region of outer-cover 111 and/or of inner-cover 113 may be attached to a tab 102 of bracket 101. In some embodiments, with respect to assembled pull-down-assembly 100, each tab 102 may be attached to an upper region of outer-cover 111 and/or of inner-cover 113 (e.g., using fastener(s) 107). In some embodiments, with respect to assembled pull-down-assembly 100, a portion of bracket 101 may cover over a top of: linear-extension-subassembly 109, outer-cover 111, and/or inner-cover 113. In some embodiments, with respect to assembled pull-down-assembly 100, inner-cover 113 may be located closer to can 123 (or closer to integrated-lighting-module 200) as compared to a closest outer-cover 111. In some embodiments, with respect to assembled pull-down-assembly 100 and with further respect to a given linear-extension-subassembly 109, inner-cover 113 may be located closer to can 123 (or closer to integrated-lighting-module 200) as compared to outer-cover 111 of that given linear-extension-subassembly 109. In some embodiments, when can 123 (with integrated-lighting-module 200) may be extended (e.g., as shown in FIG. 3A), descendable-ascendable-subassembly 117 may be (vertically down or up) movable with respect to bracket 101; whereas, outer-cover 111 and inner-cover 113 remain fixed and non-movable with respect to bracket 101. Continuing discussing FIG. 1A, in some embodiments, when can 123 (with integrated-lighting-module 200) may be extended (e.g., as shown in FIG. 3A), descendable-ascendable-subassembly 117 may be extend below portions of fixed outer-cover 111 and fixed inner-cover 113.

Continuing discussing FIG. 1A, in some embodiments, descendable-ascendable-subassembly 117 may comprise a first-member 119, a second-member 121, and a linkage-arm 213 (although linkage-arm 213 is not visible in FIG. 1A, see FIG. 2A for linkage-arm 213). Only bottom portions of first-member 119 and second-member 121 are visible in FIG. 1A. First-member 119 and second-member 121 are more visible in FIG. 3A.

FIG. 1B depicts pull-down-assembly 100 shown from a top right perspective view, and in its retracted (non-extended) configuration. Top regions of bracket 101, such as, top 131, as well as, top regions of can 123 are visible in FIG. 1B. In some embodiments, wiring/cabling 129 may enter can 123 (to provide electricity to integrated-lighting-module 200). In some embodiments, bracket 101 may be at a top 131 of pull-down-assembly 100. In some embodiments, top 131 may be at top surface of bracket 101 (not including top portions of attachment-structure(s) 103). In some embodiments, bottom 133 may be a bottom of pull-down-assembly 100. In some embodiments, top 131 may be disposed opposite from bottom 133. In some embodiments, bottom 133 may be lowest portion of trim 125 (or of can 123 in embodiments, without a separate trim 125 member). In some embodiments, top 131 may be a (substantially) flat and/or planar surface located at a top of pull-down-assembly 100 and/or at a top of bracket 101 (not including top portions of attachment-structure(s) 103).

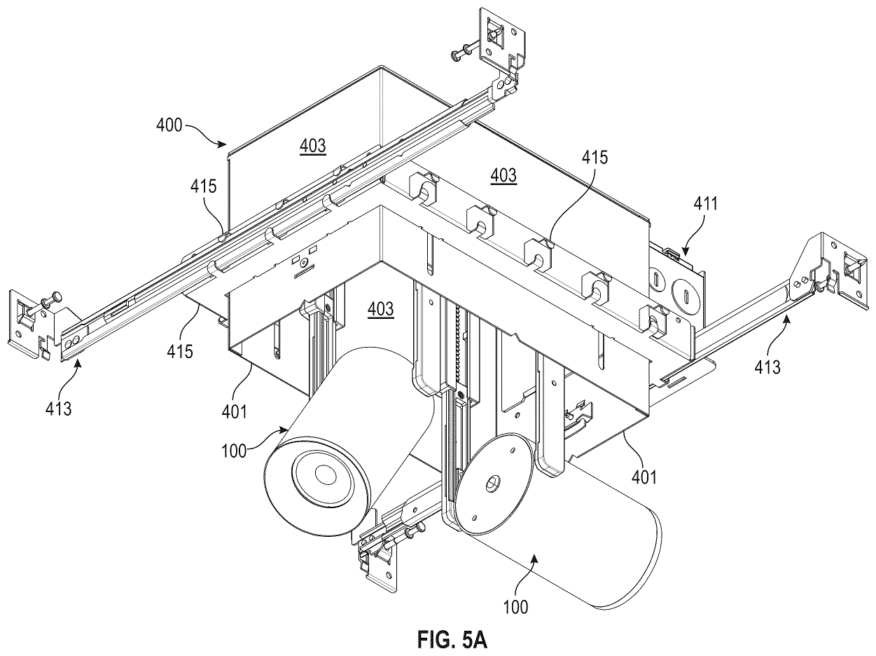

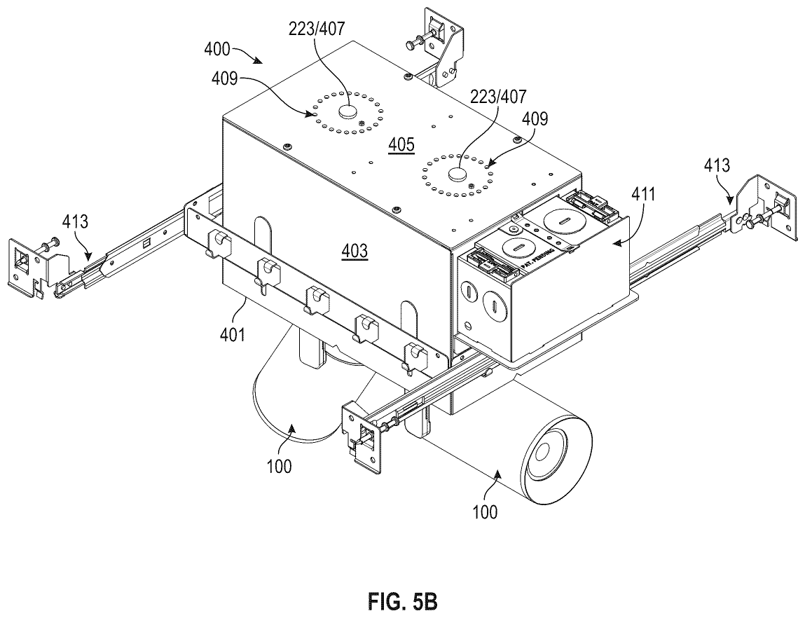

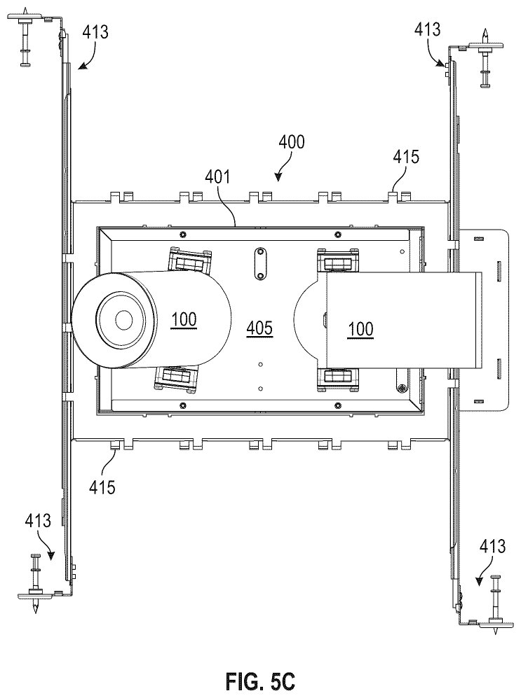

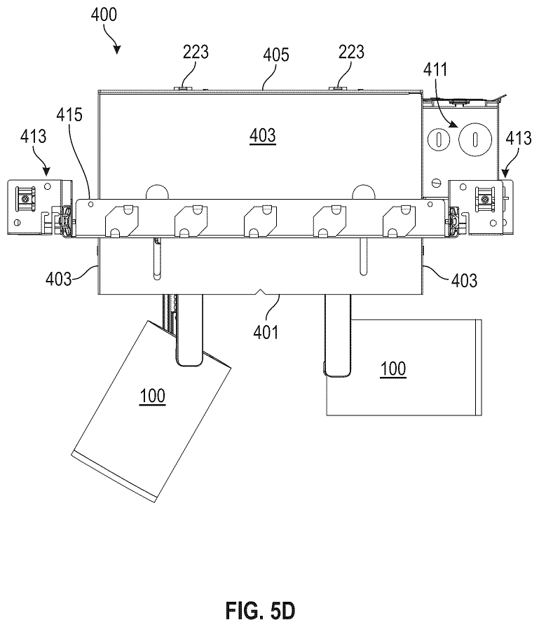

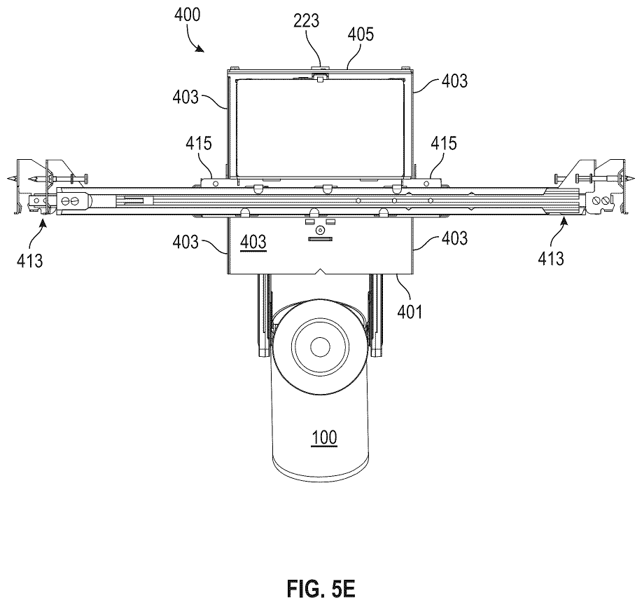

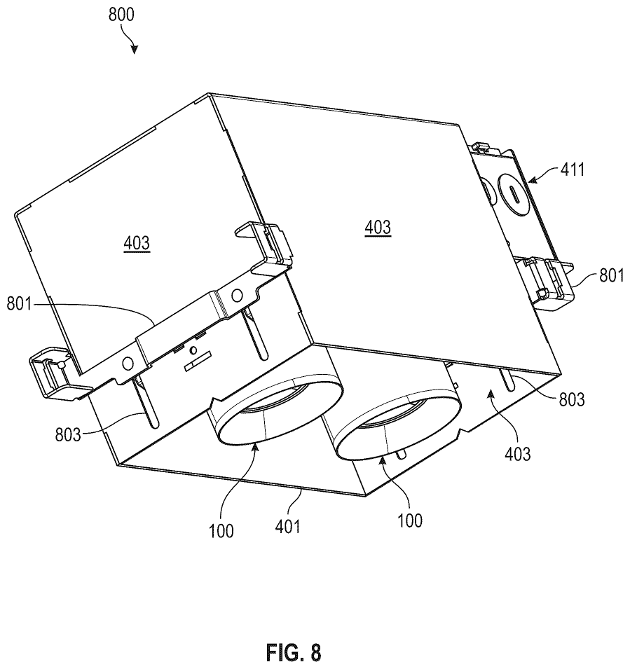

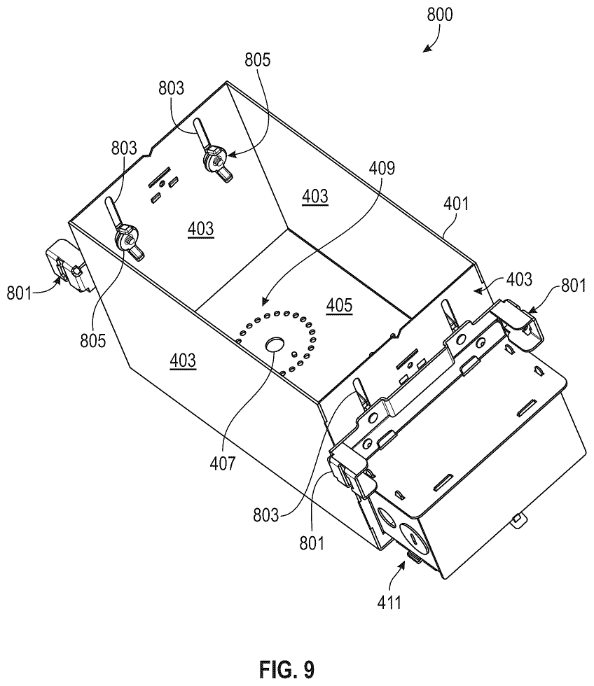

In some embodiments, when pull-down-assembly 100 may be installed below a separate structure, such as, but not limited to, a joist, a stud, a hangar-bar, and/or a housing 400 (and/or housing 800), top 131 may be attached to that separate structure (via attachment-structure(s) 103 and/or aperture(s) 105 and/or use of fastener(s)). In some embodiments, when pull-down-assembly 100 may be installed below a separate structure, such as, but not limited to, a joist, a stud, a hangar-bar, and/or a housing 400 (and/or housing 800), top 131 may abut against a bottom surface of that separate structure. In some embodiments, when pull-down-assembly 100 may be installed below a separate structure, such as, but not limited to, a joist, a stud, a hangar-bar, and/or a housing 400 (and/or housing 800), the flat and/or planar portions of top 131 may be at least substantially parallel with (to) bottom surface(s) of that separate structure. See e.g., FIG. 4A-FIG. 4D and/or FIG. 5A to FIG. 5B. (See FIG. 8 and/or FIG. 9 for housing 800.)

FIG. 1C depicts pull-down-assembly 100 shown from a front view, and in its retracted (non-extended) configuration. FIG. 1D depicts pull-down-assembly 100 shown from a rear view, and in its retracted (non-extended) configuration. In some embodiments, pull-down-assembly 100 may comprise two separate linear-extension-subassemblies 109. In some embodiments, when pull-down-assembly 100 may have two separate linear-extension-subassemblies 109, they may be disposed opposite from each other around can 123; i.e., disposed about 180 degrees opposite each other around can 123—when pull-down-assembly 100 may be in its retracted (non-extended) configuration. In some embodiments, a length of cover 111/113 may be about the same as a length of can 123; however, when pull-down-assembly 100 is in its fully retracted configuration, the length of cover 111/113 does not reach a bottom of can 123. In some embodiments, when pull-down-assembly 100 is in its fully retracted configuration, a bottom of cover 111/113 does not reach to a bottom of can 123 but may reach beyond half of the length of can 123. In some embodiments, when pull-down-assembly 100 is in its fully retracted configuration, a bottom of can 123 extends beyond a bottom of cover 111/113. In some embodiments, when pull-down-assembly 100 is in its fully retracted configuration, a top of can 123 is physically offset from a bottom of top 131 of bracket 101 because a length of linkage-arm 213 (within cover 111/113) does not permit can 123 to get any closer to bracket 101 (with respect to linear upward movement of can 123 to bracket 101) (a bottom of linkage-arm 213 is attached to a top/upper region of can 123 [see e.g., FIG. 2B]).

Continuing discussing FIG. 1C and/or FIG. 1D, in some embodiments, tabs 102 (of bracket 101) may extend perpendicularly and/or orthogonally downwards (a fixed and finite amount) and/or away from the flat plate of top 131 (see also FIG. 2B).

FIG. 1E depicts pull-down-assembly 100 shown from a top view, and in its retracted (non-extended) configuration. In some embodiments, at least some portions of bracket 101 cover over a majority of the remaining of pull-down-assembly 100, such as, but not limited, at least most of: linear-extension-subassembly 109, can 123, and trim 125. In some embodiments, from a top view of pull-down-assembly 100 and/or of bracket 101, bracket 101 has a shape that is circular (disc/disk like) at the middle of bracket 101, but with two opposing rectangular extensions that extend oppositely out from that circular middle region. And then at the distal portions of those two opposing rectangular extensions are the downward extending tabs 102 of bracket 101. In some embodiments, plate 229 from its top view (or its bottom view) may have two different half-circles, each of a different diameter.

FIG. 1F depicts pull-down-assembly 100 shown from a bottom view, and in its retracted (non-extended) configuration. FIG. 1F shows bottom portions of linear-extension-subassembly 109. FIG. 1F shows outer-cover 111 and inner-cover 113 forming a housing around descendable-ascendable-subassembly 117, with that housing having an opening 135 at the bottom of that housing to permit descendable-ascendable-subassembly 117 to descend (or ascend), at least partially, through that opening 135. That housing is formed from joining outer-cover 111 and inner-cover 113 together. In some embodiments, descendable-ascendable-subassembly 117 may comprise at least two members of first-member 119 and second-member 121.

FIG. 1G depicts pull-down-assembly 100 shown from a right-side view, and in its retracted (non-extended) configuration. FIG. 1H depicts pull-down-assembly 100 shown from a left-side view, and in its retracted (non-extended) configuration.

FIG. 2A depicts pull-down-assembly 100, shown from a bottom right perspective and exploded view. FIG. 2B depicts pull-down-assembly 100 shown from a front exploded view. FIG. 2A and FIG. 2B show integrated-lighting-module 200 and electrical-connector 201. In some embodiments, at least one electrical-connector 201 may facilitate electrical communication between wiring/cabling 129 and electronic component(s) and/or hardware of integrated-lighting-module 200. In some embodiments, electrical-connector 201 may be configured to attach to a terminal end of wiring/cabling 129 (and within can 123). In some embodiments, electrical-connector 201 may be configured to attach to wiring/cabling of integrated-lighting-module 200. In some embodiments, in the assembled configuration of pull-down-assembly 100, electrical-connector(s) 201 may be located within can 123.

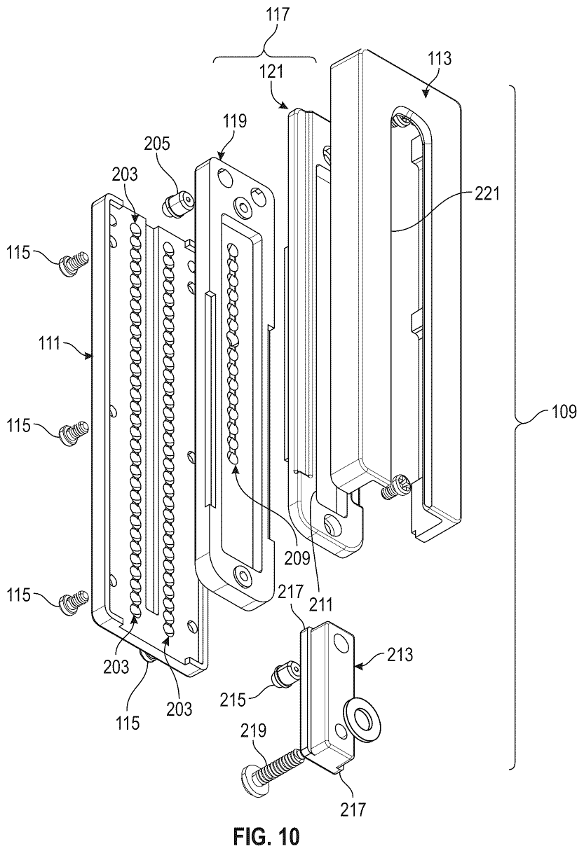

FIG. 2A and FIG. 2B details of linear-extension-subassembly 109. See also, FIG. 10 for a close up (detail) view of a region of FIG. 2A that shows exploded perspective details of one (1) linear-extension-subassembly 109 showing its portion(s) and/or component(s) thereof. FIG. 2A (and FIG. 10) may show that in some embodiments, an inside (interior) surface of outer-cover 111 may comprise at least one string-of-recessed-portions 203. In some embodiments, the inside (interior) surface of outer-cover 111 may comprise at least two, side-by-side, string-of-recessed-portions 203. Note, in the assembled configuration of pull-down-assembly 100, string-of-recessed-portions 203 of outer-cover 111 are not visible from an exterior of outer-cover 111. In some embodiments, each string-of-recessed-portions 203 may run in a straight linear line on the inside (interior) surface of outer-cover 111. When pull-down-assembly 100 is installed in a ceiling (and assembled) and when pull-down-assembly 100 is in its retracted (non-extended) configuration, each string-of-recessed-portions 203 may be oriented in a vertical straight linear line (with respect to a horizontal plane of that ceiling). In some embodiments, each string-of-recessed-portions 203 may comprise a plurality of recessed-portions alternating with a plurality of non-recessed-portions, wherein the recessing is into the inside (interior) surface of outer-cover 111. In some embodiments, each recessed-portion of each string-of-recessed-portions 203, may have a hemispherical (half-sphere) shape that is recessed into the inside (interior) surface of outer-cover 111.

Continuing discussing FIG. 2A and FIG. 2B (and FIG. 10), in some embodiments, linear-extension-subassembly 109 may comprise at least one recessed-portion-engager (raised-bump) 205. In some embodiments, for each string-of-recessed-portions 203, there may be one recessed-portion-engager (raised-bump) 205. For example, and without limiting the scope of the present invention, when a given outer-cover 111 may have two separate and distinct strings-of-recessed-portions 203, then the linear-extension-subassembly 109 of which that outer-cover 111 is part of, may have two separate and distinct recessed-portion-engagers (raised-bumps) 205 (one for each string-of-recessed-portions 203 of that given outer-cover 111). In some embodiments, a given recessed-portion-engager (raised-bump) 205 may have a terminal end portion with a shape that fits complementary and separately into each recessed-portion of a given string-of-recessed-portions 203 (but not fitting into all recessed-portions of a given string-of-recessed-portions 203 at once, just one recessed-portion at a time). In some embodiments, a given recessed-portion-engager (raised-bump) 205 may have a terminal end portion with a solid hemispherical (half-sphere) shape. In some embodiments, a given recessed-portion-engager (raised-bump) 205 may have an opposite terminal end portion (e.g., opposite from the hemispherical shape terminal end) that is attached to a surface of first-member 119 that is facing away from can 123, such that given recessed-portion-engager (raised-bump) 205 and that first-member 119 translate (move and/or slide) together as one sub-assembly. In this way, the given recessed-portion-engager (raised-bump) 205 (and its attached first-member 119) may move up or down, in a straight linear fashion, along its associated (facing) string-of-recessed-portions 203 of the given outer-cover 111, with each recessed-portion of that string-of-recessed-portions 203 acting as a frictional stopping point. The motive upward or downward force is generally applied to the can 123 and/or the trim 125, by a human pushing up or pulling down, wherein the motive force may be greater than the frictional force of a recessed-portion of the string-of-recessed-portions 203 being physically engaged with the given recessed-portion-engager (raised-bump) 205.

Continuing discussing FIG. 2A (and FIG. 10), in some embodiments, first-member 119 may comprise at least one string-of-recessed-portions 209. Recall, in some embodiments, on the surface of first-member 119 that is facing away from can 123, that at least one recessed-portion-engager (raised-bump) 205 may be attached to that outward facing surface of first-member 119. Whereas, in some embodiments, on a surface of first-member 119 that is facing can 123, may be at least one string-of-recessed-portions 209. That is, in some embodiments, an inner facing surface of first-member 119 may comprise at least one string-of-recessed-portions 209. In some embodiments, with respect to a given first-member 119, that first-member 119 may comprise one or two attached recessed-portion-engager (raised-bump) 205 on an outer facing surface and may comprise at least one string-of-recessed-portions 209 on an opposite inner facing surface (of that first-member 119). Note, in the assembled configuration of pull-down-assembly 100, string-of-recessed-portions 209 of first-member 119 are not visible from an exterior of linear-extension-subassembly 109. In some embodiments, string-of-recessed-portions 209 may run in a straight linear line on the inner facing surface of first-member 119. When pull-down-assembly 100 is installed in a ceiling (and assembled) and when pull-down-assembly 100 is in its retracted (non-extended) configuration, string-of-recessed-portions 209 may be oriented in a vertical straight linear line (with respect to a horizontal plane of that ceiling). When pull-down-assembly 100 is installed in a ceiling (and assembled) and when pull-down-assembly 100 is in its retracted (non-extended) configuration, string-of-recessed-portions 209 may run in a direction that parallel with the run direction(s) of string-of-recessed-portions 203. Note, string-of-recessed-portions 209 and string-of-recessed-portions 203 are portions of entirely different parts (components), namely, first-member 119 and outer-cover 111, respectively. In some embodiments, string-of-recessed-portions 209 may comprise a plurality of recessed-portions alternating with a plurality of non-recessed-portions, wherein the recessing is into the inner surface of first-member 119. In some embodiments, each recessed-portion of string-of-recessed-portions 209, may have a hemispherical (half-sphere) shape that is recessed into the inner surface of first-member 119.

Note, in some embodiments, string-of-recessed-portions 203 may be longer than string-of-recessed-portions 209. In some embodiments, string-of-recessed-portions 209 may be shorter than string-of-recessed-portions 203. In some embodiments, two separate and distinct strings-of-recessed-portions 203 have same lengths to each other that may be parallel with a length of outer-cover 111. In some embodiments, string-of-recessed-portions 209 has a length that is parallel with a length of first-member 119. In some embodiments, the lengths of the two separate and distinct strings-of-recessed-portions 203 flank (are adjacent) to a centerline of outer-cover 111, wherein that centerline of outer-cover 111 is running in the length direction of outer-cover 111. Whereas, in some embodiments, the length of string-of-recessed-portions 209 is coincident and colinear (not flanking and not adjacent to) a centerline of first-member 119, wherein that centerline of first-member 119 is running in the length direction of first-member 119. See e.g., FIG. 2A (and FIG. 10).

Continuing discussing FIG. 2A and FIG. 2B (and FIG. 10), in some embodiments, linear-extension-subassembly 109 may comprise at least one linkage-arm 213. In some embodiments, linkage-arm 213 may be an intermediary member with a portion that attaches to can 123 and with a different portion that is retained within descendable-ascendable-subassembly 117. Recall, descendable-ascendable-subassembly 117 may be made up of (and/or comprise) first-member 119 and second-member 121, when first-member 119 is attached to second-member 121. In some embodiments, linkage-arm 213 may be rigid elongate member (of a fixed length) that is “T” shaped in cross-section (i.e., when linkage-arm 213 may be viewed from a top or a bottom its shape resembles a capital letter “T.”) In some embodiments, the arm (or bar) portions of a capital letter “T” shape of linkage-arm 213 form lips (flanges) 217 of linkage-arm 213. In some embodiments, linkage-arm 213 may have (comprise) two opposing terminal ends. In some embodiments, at one terminal end of linkage-arm 213, that linkage-arm 213 may be configured to be attached to can 123 (e.g., via fastener 219, apertures, and a washer). In some embodiments, at one terminal end of linkage-arm 213, that linkage-arm 213 may comprise an aperture that is configured to receive at least a portion of fastener 219, wherein at least some portions of fastener 219 are configured to be received into an aperture located in an upper region of can 123. In some embodiments, at the other and opposing terminal end of linkage-arm 213, that linkage-arm 213 may comprise structure for attaching to a recessed-portion-engager (raised-bump) 215.

Continuing discussing FIG. 2A and FIG. 2B (and FIG. 10), in some embodiments, linear-extension-subassembly 109 (and/or descendable-ascendable-subassembly 117 and/or linkage-arm 213) may comprise at least one recessed-portion-engager (raised-bump) 215. In some embodiments, for each string-of-recessed-portions 209 (of each first-member 119), there may be one complementary recessed-portion-engager (raised-bump) 215. For example, and without limiting the scope of the present invention, when a given first-member 119 may have one string-of-recessed-portions 209, then the linear-extension-subassembly 109 of which that first-member 119 is part of, may have one recessed-portion-engagers (raised-bumps) 215. In some embodiments, a given recessed-portion-engager (raised-bump) 215 may have a terminal end portion with a shape that fits complementary and separately into each recessed-portion of a given string-of-recessed-portions 209 (but not fitting into all recessed-portions of a given string-of-recessed-portions 209 at once, just one recessed-portion at a time). In some embodiments, a given recessed-portion-engager (raised-bump) 215 may have a terminal end portion with a solid hemispherical (half-sphere) shape. In some embodiments, a given recessed-portion-engager (raised-bump) 215 may have an opposite terminal end portion (e.g., opposite from the hemispherical shape terminal end) that is attached to a terminal end of linkage-arm 213 (disposed away from the other terminal end of linkage-arm 213 that is attached to can 123), such that given recessed-portion-engager (raised-bump) 215 and that linkage-arm 213 translate (move and/or slide) together as one sub-assembly. In this way, the given recessed-portion-engager (raised-bump) 215 (and its attached linkage-arm 213) may move up or down, in a straight linear fashion, along its associated (facing) string-of-recessed-portions 209 of the given first-member 119, with each recessed-portion of that string-of-recessed-portions 209 acting as a frictional stopping point. The motive upward or downward force is generally applied to the can 123 and/or the trim 125, by a human pushing up or pulling down, wherein the motive force may be greater than the frictional force of a recessed-portion of the string-of-recessed-portions 209 being physically engaged with the given recessed-portion-engager (raised-bump) 215.

Continuing discussing FIG. 2A and FIG. 2B (and FIG. 10), in some embodiments, the portion of linkage-arm 213 with its attached recessed-portion-engager (raised-bump) 215 may be movingly retained within the subassembly of first-member 119 and second-member 121, with the rounded solid hemispherical shape of recessed-portion-engager (raised-bump) 215 being frictionally engageable against recessed-portions of string-of-recessed-portions 209 of first-member 119. In some embodiments, with respect to assembled linear-extension-subassembly 109 (or assembled descendable-ascendable-subassembly 117), at least portions of linkage-arm 213 (including its attached recessed-portion-engager (raised-bump) 215) may be disposed between first-member 119 and second-member 121. In some embodiments, lip(s) 217, of linkage-arm 213, may help portions of linkage-arm 213 to be movingly retained within the subassembly of first-member 119 and second-member 121. In some embodiments, linkage-arm 213 (along with its attached recessed-portion-engager (raised-bump) 215) may move linearly straight up or down with respect to subassembly of first-member 119 and second-member 121. Similarly, linkage-arm 213, along with attached can 123, may move linearly straight up or down with respect to subassembly of first-member 119 and second-member 121 (because linkage-arm 213 may be attached to can 123). The attachment between can 123 and linkage-arm 213 (e.g., using fasteners 219 and washers or the like) does not permit linear movement between can 123 and linkage-arm 213. However, in some embodiments, rotational movement (e.g., about an axis running through lengths of fasteners 219) between can 123 and linkage-arm 213 may be permitted. Also, recall, in some embodiments, the sub-assembly of first-member 119 and second-member 121 (and linkage-arm 213 retained therein) may move slidingly and linearly straight up or down with respect to the sub-assembly of outer-cover 111 to inner-cover 113. However, the sub-assembly of outer-cover 111 to inner-cover 113 may be fixedly attached to bracket 101, such that the sub-assembly of outer-cover 111 to inner-cover 113 and bracket 101 do not move with respect to each other. See e.g., FIG. 2A, FIG. 2B, FIG. 1A, and FIG. 3A.

In some embodiments, linkage-arm 213 may comprise at least one other part (component) of: recessed-portion-engager (raised-bump) 215 and/or fastener 219. And/or, linear-extension-subassembly 109 comprise linkage-arm 213, recessed-portion-engager (raised-bump) 215, and fastener 219 (as well as, descendable-ascendable-subassembly 117). And/or, descendable-ascendable-subassembly 117 comprise linkage-arm 213, recessed-portion-engager (raised-bump) 215, and fastener 219. (Descendable-ascendable-subassembly 117 may also comprise first-member 119 and second-member 121.) See e.g., FIG. 2A, FIG. 2B, FIG. 1A, FIG. 3A, and FIG. 10.

Continuing discussing FIG. 2A (and FIG. 10), in some embodiments, second-member 121 may comprise at least one slot 211. In some embodiments, this slot 211 (of second-member 121) may have a length that is parallel with an overall length of second-member 121. In some embodiments, this slot 211 may be enclosed everywhere in two dimensions (2D) along its periphery, including sides, top, and bottom. In some embodiments, this slot 211 may be configured to receive and/or retain portions of linkage-arm 213 therein.

Continuing discussing FIG. 2A (and FIG. 10), in some embodiments, inner-cover 113 may comprise at least one channel 221. In some embodiments, channel 221 may be visible from an inner facing surface of inner-cover 113 and/or form an outer facing surface of inner-cover 113, wherein the inner facing surface and the outer facing service are with respect to can 123 when pull-down-assembly 100 is in an assembled configuration. In some embodiments, this channel 221 (of inner-cover 113) may have a length that is parallel with an overall length of inner-cover 113. In some embodiments, this channel 221 may be enclosed everywhere in two dimensions (2D) along its periphery, including along its sides and its top—but open at its bottom. In some embodiments, this channel 221 may be open at its bottom. In some embodiments, both inner-cover 113 and outer-cover 111 may be open at their bottom, to enable downwards or upwards linear straight movement of at least portions of descendable-ascendable-subassembly 117 (including that of linkage-arm 213) out of that bottom opening. In some embodiments, this channel 221 may be configured to allow (permit and/or facilitate) downwards or upwards linear straight movement of at least portions of linkage-arm 213 within that channel 221.

Continuing discussing FIG. 2A and FIG. 2B, in some embodiments, attachment-structure 103 (of bracket 101) may comprise at least one of: a bolt (screw) 223, an aperture 225 (a largest aperture of bracket 101), a nut 227, and/or a plate 229. In some embodiments, bolt 223 may be a bolt, a screw, a threaded fastener, a rivet, a fastener, and/or the like. In some embodiments, aperture 225 may be a through hole that passes entirely through a thickness of bracket 101. In some embodiments, aperture 225 may be largest hole in bracket 101. In some embodiments, aperture 225 may be bigger (larger) than aperture(s) 105. In some embodiments, aperture 225 may be disposed between apertures 105. In some embodiments, aperture 225 may be flanked on two sides by an aperture 105. In some embodiments, aperture 225 may be located equidistant from two opposing apertures 105. In some embodiments, aperture 225 may be located in a center of top 131 of bracket 101. In some embodiments, a threaded portion of bolt 223 may be configured to pass through aperture 225. In some embodiments, an outside diameter of the threaded portion of bolt 223 and a dimension of aperture 225 (such as, but not limited, to an inside diameter) may be complementary sized to each other to permit at least some of the threaded portion of bolt 223 to pass entirely through aperture 225. In some embodiments, nut 227 may be a nut with female threads that are configured to complementary mate with male threads of bolt 223. In some embodiments, plate 229 may be rigid plate (with a center through hole). In some embodiments, attachment-structure 103 (of bracket 101) may be used to attach pull-down-assembly 100 (via bracket 101) to structure(s) external to pull-down-assembly 100, such as, but not limited to, a joist, a stud, a hangar-bar, and/or housing 400 (and/or housing 800).

Continuing discussing FIG. 2B, in some embodiments, pull-down-assembly 100 and/or bracket 101 may at least one fastener 231. In some embodiments, fastener 231 may be configured to fit through and/or into aperture 105 of bracket 101. In some embodiments, pull-down-assembly 100 and/or bracket 101 may two separate and distinct fasteners 231. In some embodiments, a quantity of fastener(s) 231 may numerically match a quantity of aperture(s) 105 in bracket 101. In some embodiments, fastener(s) 231 and aperture(s) 105 (of bracket 101) may be used to attach pull-down-assembly 100 to structure(s) external to pull-down-assembly 100, such as, but not limited to, a joist, a stud, a hangar-bar, and/or housing 400 (and/or housing 800).

Continuing discussing FIG. 2B, in some embodiments, pull-down-assembly 100 and/or can 123 may at least one grommet (gasket) 233. In some embodiments, grommet (gasket) 233 may be grommet and/or a gasket. In some embodiments, grommet (gasket) 233 may be wire/cable grommet and/or a wire/cable gasket. In some embodiments, grommet (gasket) 233 may be made from an elastomeric, waterproof, and/or electrically resistive material, such as, but not limited to, silicone, rubber, and/or the like. In some embodiments, grommet (gasket) 233 may provide a means for a portion of wiring/cabling 129 to safely enter can 123 (without being cut or damaged) and/or for a portion of wiring/cabling 129 to be securely attached (fastened and/or anchored) to can 123.

FIG. 3A depicts pull-down-assembly 100, shown from a bottom right perspective view, and in an extended (non-retracted) configuration. FIG. 3B depicts pull-down-assembly 100, shown from a top right perspective view, and in the extended (non-retracted) configuration. FIG. 3C depicts pull-down-assembly 100, shown from a rear view, and in the extended (non-retracted) configuration. FIG. 3D depicts pull-down-assembly 100, shown from a front view, and in the extended (non-retracted) configuration. FIG. 3E depicts pull-down-assembly 100, shown from a right-side view, and in the extended (non-retracted) configuration. FIG. 3F depicts pull-down-assembly 100, shown from a bottom view, and in the extended (non-retracted) configuration. FIG. 3G depicts pull-down-assembly 100, shown from a top view, and in the extended (non-retracted) configuration.

In FIG. 3A through FIG. 3G, descendable-ascendable-subassembly 117 (the sub-assembly of first-member 119 and second-member 121) is shown in a fully extended configuration with respect to the sub-assembly of outer-cover 111 and inner-cover 113. In FIG. 3A through FIG. 3G, descendable-ascendable-subassembly 117 (the sub-assembly of first-member 119 and second-member 121) are fully extended from the sub-assembly of outer-cover 111 and inner-cover 113. In FIG. 3A through FIG. 3G, descendable-ascendable-subassembly 117 (the sub-assembly of first-member 119 and second-member 121) are extended at least partially out from bottom openings of the sub-assembly of outer-cover 111 and inner-cover 113. In FIG. 3A through FIG. 3G, the linkage-arms 213 are shown in a fully extended configuration with respect to the sub-assembly of first-member 119 and second-member 121 (descendable-ascendable-subassembly 117) (although the linkage-arms 213 are not directly visible in FIG. 3A through FIG. 3G). Also, shown in FIG. 3A through FIG. 3G, pull-down-assembly 100 is shown where can 123 is rotated with respect to descendable-ascendable-subassembly 117.

Additionally, FIG. 3C and FIG. 3D include (straight and double-headed) arrow-indicating-downwards-or-upwards-linear-movement 300. In some embodiments, arrow-indicating-downwards-or-upwards-linear-movement 300 may indicate that descendable-ascendable-subassembly 117 (the sub-assembly of first-member 119 and second-member 121) are extendable from and with respect to the sub-assembly of outer-cover 111 and inner-cover 113. In some embodiments, arrow-indicating-downwards-or-upwards-linear-movement 300 may indicate that the linkage-arms 213 are extendable from and with respect to the sub-assembly of first-member 119 and second-member 121 (descendable-ascendable-subassembly 117). In some embodiments, arrow-indicating-downwards-or-upwards-linear-movement 300 may indicate that can 123 (by virtue of linkage-arms 213) is extendable from and with respect to the sub-assembly of first-member 119 and second-member 121 (descendable-ascendable-subassembly 117). In some embodiments, arrow-indicating-downwards-or-upwards-linear-movement 300 may indicate that can 123 is extendable from and with respect to the sub-assembly of sub-assembly of outer-cover 111 and inner-cover 113. In some embodiments, arrow-indicating-downwards-or-upwards-linear-movement 300 may indicate that can 123 is extendable from and with respect to bracket 101. Arrow 300 is depicted as straight and as double-headed to indicate such linear downwards or upwards movements. The structural geometry and relationships that enable this linear downwards or upwards movement are shown in the exploded views of FIG. 2A and FIG. 2B and discussed in their discussions.

With respect to FIG. 3C (and/or FIG. 3D), in some embodiments, when pull-down-assembly 100 is in its fully extended configuration, a bottom of descendable-ascendable-subassembly 117 does not reach to a half of the length of can 123 (and when can 123 is not rotated; i.e., a length of can 123 remains parallel with a length of cover 111/113 or is rotated less than thirty (30) degrees). In some embodiments, when pull-down-assembly 100 is in its fully extended configuration, a top of can 123 is below a bottom of cover 111/113. In some embodiments, when pull-down-assembly 100 is in its fully extended configuration, a top of can 123 is below a bottom of cover 111/113 but above a bottom of descendable-ascendable-subassembly 117 (and when can 123 is not rotated; i.e., a length of can 123 remains parallel with a length of cover 111/113 or is rotated less than thirty (30) degrees). See e.g., FIG. 3C and/or FIG. 3D; see also FIG. 5D.

Additionally, FIG. 3E includes curved-arrow-indicating-rotational-movement 350. In some embodiments, curved-arrow-indicating-rotational-movement 350 may indicate that can 123 (by virtue of linkage-arms 213 and fasteners 219) is rotatable with respect to the sub-assembly of first-member 119 and second-member 121 (descendable-ascendable-subassembly 117). This rotation may be about a shared axis passing through fasteners 219 and coaxial and parallel with the lengths of fasteners 219. The structural geometry and relationships that enable this rotational movement are shown in the exploded views of FIG. 2A and FIG. 2B and discussed in their discussions.

FIG. 4A shows two separate and distinct pull-down-assemblies 100 mounted within a housing (enclosure) 400, shown from a bottom (right) perspective view; and wherein the pull-down-assemblies 100 that are mounted within housing 400 are in their retracted (non-extended) configuration. FIG. 4B shows the housing 400 from FIG. 4A (and still with the two separate and distinct pull-down-assemblies 100 mounted therein), but now shown from a top perspective view. However, in FIG. 4B the two separate and distinct pull-down-assemblies 100 that are mounted within the housing 400 are not visible. FIG. 4C shows the housing 400 from FIG. 4A (and still with the two separate and distinct pull-down-assemblies 100 mounted therein), but now shown from a bottom view.

Note, as shown in FIG. 4C, the two separate and distinct pull-down-assemblies 100 mounted within housing 400, are not mounted in the exact same orientation (with respect to each other and/or with respect to housing 400 [and/or with respect to top-panel 405])—and this mounting orientation variability is discussed in the discussion of plurality-of-apertures 409 region(s) of a top-panel 405.

FIG. 4D shows the housing 400 from FIG. 4A (and still with the two separate and distinct pull-down-assemblies 100 mounted therein), but now shown from a top view (the two separate and distinct pull-down-assemblies 100 mounted therein are not visible in FIG. 4D). FIG. 4E shows the housing 400 from FIG. 4A (and still with the two separate and distinct pull-down-assemblies 100 mounted therein), but now shown from a right-side view (only bottom most portions of the two separate and distinct pull-down-assemblies 100 mounted therein are only just barely visible in FIG. 4E). FIG. 4F shows the housing 400 from FIG. 4A (and still with the two separate and distinct pull-down-assemblies 100 mounted therein), but now shown from a front view (only a bottom most portion of one of the two separate and distinct pull-down-assemblies 100 mounted therein is only just barely visible in FIG. 4F).

Discussing FIG. 4A to FIG. 4F, in some embodiments, housing 400 may be a housing and/or an enclosure that is configured to receive at least one: light fixture, light source, lighting module, integrated-lighting-module, integrated-lighting-module 200, pull-down-assembly 100, combinations thereof, a portion thereof, and/or the like. In some embodiments, housing 400 may be a housing and/or an enclosure that is configured such that at least one of the following may be attached within housing (enclosure) 400: a light fixture, a light source, a lighting module, an integrated-lighting-module, an integrated-lighting-module 200, a pull-down-assembly 100, combinations thereof, a portion thereof, and/or the like. In some embodiments, housing 400 may have a generally and/or a substantially three-dimensional (3D) shape of a rectangular prism, a cuboid, and/or a cube (not including its junction-box 411, its hanger-bars 413, nor its means 415 for attaching the hangar-bars to a sidewall of housing 400). In some embodiments, housing 400 may have a generally and/or a substantially 3D shape of at least six main (largest) sides (e.g., a top, a bottom, a right-side, a left side, a front-side, and a rear-side).

In some embodiments, the 3D shape of housing 400 may be at least mostly (substantially) closed on all sides, except open at its bottom side (its bottom-main-opening 401). In some embodiments, bottom-main-opening 401 may be largest opening and a main opening of housing 400 located at the bottom of housing 400. In some embodiments, at least most internals of housing 400 may be accessed through and/or by bottom-main-opening 401. In some embodiments, at least one pull-down-assembly 100 may be mounted within housing 400. In some embodiments, two separate and distinct pull-down-assemblies 100 may be mounted within housing 400.

Continuing discussing FIG. 4A to FIG. 4F, in some embodiments, housing 400 may comprise four sidewalls 403 and one top-panel 405, all disposed around a main (largest) hollow central volume of housing 400 and around/above bottom-main-opening 401. In some embodiments, bottom-main-opening 401 may be a largest opening to main (largest) hollow central volume of housing 400 where at least one pull-down-assembly 100 may occupy at least some of the volume when installed within that given housing 400. That main (largest) hollow central volume of housing 400 may be where one or two pull-down-assemblies 100 are located therein. In some embodiments, each of the four sidewalls 403 and one top-panel 405, may be mostly (substantially) flat and/or planar members, made out of sheet metal (wherein sheet metal may be bent and/or stamped into the shapes of the four sidewalls 403 and one top-panel 405). In some embodiments, the four sidewalls 403 may be made up of a front sidewall, a rear sidewall, a right-side sidewall, and a left-side sidewall. The front sidewall may be attached to (or physically touching) the right-side sidewall and the left-side sidewall. The front sidewall is not attached to nor physically touching the rear sidewall. The rear sidewall may be attached to (or physically touching) the right-side sidewall and the left-side sidewall. The right-side sidewall is not attached to nor physically touching the left-side sidewall. The front sidewall and rear sidewall may be disposed opposite from each other (and are parallel with each other) and are separated from each other by the right-side sidewall and the left-side sidewall. Similarly, the right-side sidewall and the left-side sidewall may be disposed opposite from each other (and are parallel with each other), being separated from each other by the front sidewall and the rear sidewall. In some embodiments, the sidewalls 403 may be mostly (substantially) closed (but may include some openings).

Continuing discussing FIG. 4A to FIG. 4F, in some embodiments, the largest (main) planes of the four sidewalls 403 may be orthogonal to a largest (main) plane of the top-panel 405. In some embodiments, the top-panel 405 may be a largest top panel region (portion) of housing 400. In some embodiments, top-panel 405 may be attached to and/or physically touching each of the four sidewalls 403. In some embodiments, top-panel 405 may be mostly closed, aside from aperture(s) 407 and plurality-of-apertures 409 region(s). In some embodiments, top-panel 405 may comprise at least one aperture 407. In some embodiments, top-panel 405 may comprise two separate and distinct apertures 407. In some embodiments, aperture(s) 407 may be through hole, passing entirely through a thickness of top-panel 405. In some embodiments, aperture(s) 407 may be located in top-panel 405, for engaging, interacting, and/or attaching to/with attachment-structure(s) 103 or portions thereof of a given bracket 101. In some embodiments, a diameter of aperture 407 may be sized to fit therein threaded portions of bolt 223. In some embodiments, top-panel 405 may comprise at least one plurality-of-apertures 409 region. In some embodiments, top-panel 405 may comprise two separate and distinct plurality-of-apertures 409 regions. In some embodiments, a given plurality-of-apertures 409 region may be comprised of a plurality of same sized holes arranged in a circular pattern in top-panel 405. In some embodiments, the plurality of same sized holes of a given plurality-of-apertures 409 region may comprise twenty-four (24) different same sized holes arranged in the circular pattern top-panel 405. In some embodiments, the plurality of same sized holes of a given plurality-of-apertures 409 region may comprise twelve (12) pairs of oppositely disposed different same sized holes arranged in the circular pattern top-panel 405. Each same sized holes arranged in a circular pattern may be configured to fit a threaded portion of fastener(s) 231. In some embodiments, each pair of oppositely positioned same sized holes, selected from a given plurality-of-apertures 409 region, may be separated from each other by the exact same distance as a pair of apertures 105 on bracket 101 are separated from each other; such that, a hole from the given plurality-of-apertures 409 region and an aperture 105 may be positioned to be coaxial with each other (for a purpose of attaching bracket 101 to top-panel 405 using fastener 131). In some embodiments, located within a center of a given plurality-of-apertures 409 region may be one aperture 407. Additionally, the circular pattern of the plurality of same sized holes of a given plurality-of-apertures 409 region allows bracket 101 to be attached to top-panel 405 in a variety of rotational positions as between bracket 101 and top-panel 405 (wherein the rotational axis being the center of aperture 407 and/or the center of attachment-structure(s) 103).

Continuing discussing FIG. 4A to FIG. 4F, in some embodiments, at least one junction-box 411 may be attached to and/or physically touching a sidewall 403 of housing 400. In some embodiments, housing 400 may comprise at least one junction-box 411. In some embodiments, junction-box 411 may be an electrical junction box. In some embodiments, junction-box 411 may comprise at least one: electrical wire, electrical cable, electrical connection, a driver, a transformer, a switch, a timer, a circuit, combinations thereof, a portion thereof, and/or the like. In some embodiments, junction-box 411 may comprise at least one knockout. In some embodiments, junction-box 411 may comprise at least one industry standard sized knockout.

Continuing discussing FIG. 4A to FIG. 4F, in some embodiments, housing 400 may comprise at least one hangar-bar 413. In some embodiments, housing 400 may comprise two separate and distinct hangar-bars 413. In some embodiments, a given hangar-bar 413 may be telescoping elongate member that has a pair of opposing terminal ends that are configured to be mounted to a pair of adjacent joists (studs). And in between the pair of opposing terminal ends, the given hangar-bar 413 may be attached to and/or in communication with a sidewall 403 of housing 400. In some embodiments, housing 400 may comprise at least one means-for-attaching-hangar-bar-to-sidewall 415 (means 415). In some embodiments, means 415 may be how a given sidewall 403 of housing 400 attaches to a given hangar-bar 413. In some embodiments, means 415 may be made from sheet metal that is bent and/or stamped to form a plurality of brackets (supports) that are specifically configured to attach to and/or support a portion of a given hangar-bar 413. In some embodiments, means 415 may be a rectangular prism ring that is configured to fit around the sidewalls 403 perimeter. In some embodiments, means 415 may be attached to at least a portion of sidewalls 403 via at least one fastener(s), flaps, flanges, press fits, friction fits, clamps, and/or the like.

Note, hangar-bar(s) 413 are well understood in the lighting industry. Teachings of preexisting hangar bars are incorporated by reference herein as if fully set forth herein. In some embodiments, hangar-bar(s) 413 may be described by hangar bars and/or the like of U.S. utility patent Ser. Nos. 11/460,157 and/or 12/196,390. Teachings of U.S. utility patent Ser. Nos. 11/460,157 and/or 12/196,390 are incorporated by reference herein as if fully set forth herein.

In some embodiments, housing 400 may comprise at least of: bottom-main-opening 401, sidewall(s) 403, top-panel 405, aperture(s) 407, plurality-of-apertures 409, junction-box 411, hangar-bar(s) 413, means-for-attaching-hangar-bar-to-sidewall 415, and/or the like. See e.g., FIG. 4A to FIG. 4F.

FIG. 5A shows two separate and distinct pull-down-assemblies 100 mounted within housing 400, shown from a bottom (right) perspective view; and wherein the pull-down-assemblies 100 that are mounted within housing 400 are in their extended (non-retracted) configuration. Additionally, the pull-down-assemblies 100 that are mounted within housing 400, shown in FIG. 5A, are also in their rotated configuration. FIG. 5B shows the housing 400 from FIG. 5A (and still with the two separate and distinct pull-down-assemblies 100 mounted therein), but now shown from a top perspective view. FIG. 5C shows the housing 400 from FIG. 5A (and still with the two separate and distinct pull-down-assemblies 100 mounted therein), but now shown from a bottom view. FIG. 5D shows the housing 400 from FIG. 5A (and still with the two separate and distinct pull-down-assemblies 100 mounted therein), but now shown from a right-side view. FIG. 5D shows one of the pull-down-assemblies 100, with a length of its can 123 rotated about ninety (90) degrees from vertical (from a lengthwise direction of linear-extension-subassembly 109 and/or descendable-ascendable-subassembly 117). FIG. 5E shows the housing 400 from FIG. 5A (and still with the two separate and distinct pull-down-assemblies 100 mounted therein), but now shown from a front view.

In some embodiments, when a pull-down-assembly 100 may be attached within a given housing 400 (or housing 800); and when that attached pull-down-assembly 100 may be in its fully extended configuration, its cover(s) 111/113 may remain above bottom-main-opening 401 and/or within that housing 400, while is can 123 and at least portions of its descendable-ascendable-subassembly 117 may extend out and beyond bottom-main-opening 401 and outside of that housing 400. See e.g., FIG. 5D and/or FIG. 5E.

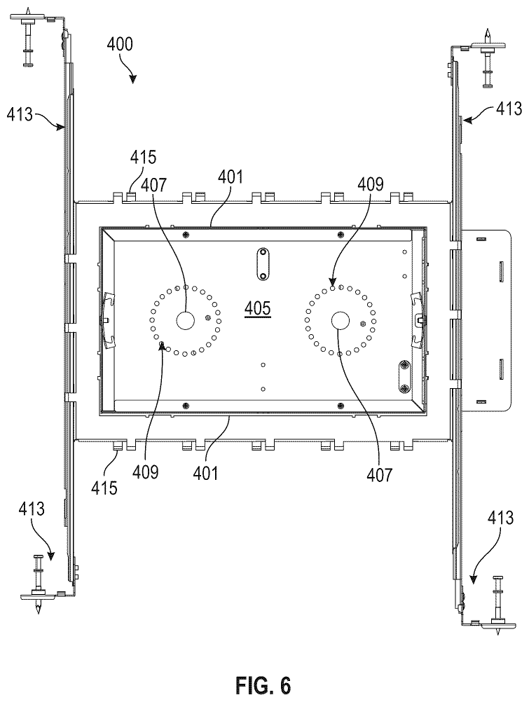

FIG. 6 shows the housing 400 from FIG. 4A (but without any pull-down-assemblies 100 mounted therein), and shown from a bottom view. Thus, FIG. 6 is similar in appearance to FIG. 4C, but without any pull-down-assemblies 100 in FIG. 6.

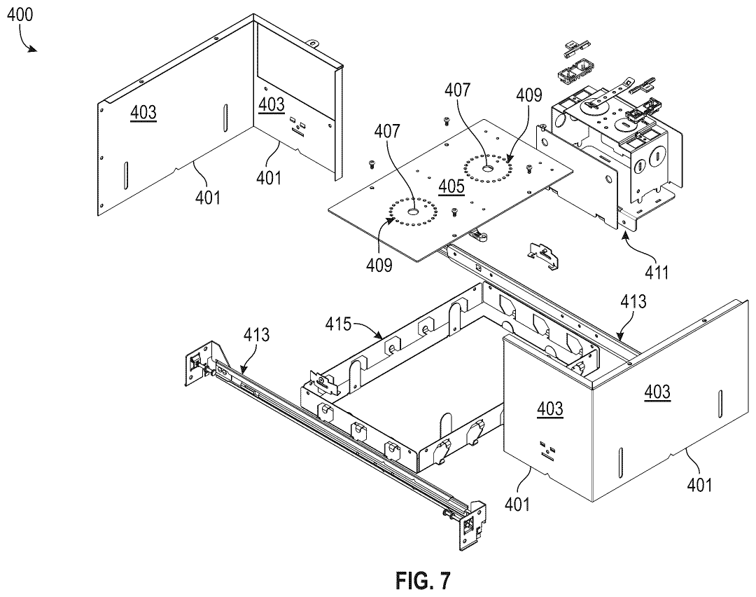

FIG. 7 shows a perspective exploded view of housing 400 (without any pull-down-assemblies 100).

FIG. 8 shows a housing (enclosure) 800 (similar to housing 400) with two separate and distinct pull-down-assemblies 100 mounted within that housing 800, shown from a bottom perspective view; and wherein the pull-down-assemblies 100 that are mounted within housing 800 are in their retracted (non-extended) configuration. Thus, FIG. 8 is similar to FIG. 4A. In some embodiments, housing 800 may comprise at least one bracket 801. In some embodiments, housing 800 may comprise two brackets 801. In some embodiments, a given bracket 801 may be attached to a given sidewall 403 (onto an exterior surface of that given sidewall 403). In some embodiments, bracket 801 may be configured for attachment to hangar-bar(s), joists, studs, and/or the like.

FIG. 9 shows housing 800 without any pull-down-assemblies 100 included within that housing 800, shown from a bottom perspective view. In some embodiments, housing 800 may be substantially similar to housing 400, except housing 800 may not include hangar-bar(s) 413 and means 415 (in some embodiments); and/or housing 800 may comprise at least one bracket 801. In some embodiments, housing 800 may comprise at least of: bottom-main-opening 401, sidewall(s) 403, top-panel 405, aperture(s) 407, plurality-of-apertures 409, junction-box 411, hangar-bar(s) 413, means-for-attaching-hangar-bar-to-sidewall 415, bracket(s) 801, slot(s) 803, clamp(s) 805, and/or the like. In some embodiments, housing 800 may comprise at least of: bottom-main-opening 401, sidewall(s) 403, top-panel 405, aperture(s) 407, plurality-of-apertures 409, junction-box 411, bracket(s) 801, slot(s) 803, clamp(s) 805, and/or the like. In some embodiments, bracket 801 may be attached to an exterior sidewall 403 of housing 800. In some embodiments, two opposing sidewalls 403 of housing 800 may each have a single bracket 801 attached externally thereto. In some embodiments, a given bracket 801 may be attached to a given sidewall 403 (onto an exterior surface of that given sidewall 403), by an elongate member portion of that given bracket 801 (which may be threaded in some embodiments) extending through a slot 803 in that sidewall, and then having elongate member portion of that given bracket 801 that is located on the internal (interior) side of that sidewall 403 secured with a clamp 805. In some embodiments, clamp 805 may be wing nut, a nut, a washer, combinations thereof, and/or the like. In some embodiments, loosening clamp(s) 805 may permit vertical adjustment (movement) of bracket 801 up or down along the exterior of that sidewall 403, by a fixed and finite length of the slot(s) 803 of that sidewall 403. In some embodiments, to attach a given bracket 801 to a given sidewall 403, may utilize two such separate and distinct slots 803 and two such separate and distinct clamps 805, per a given sidewall 403. In some embodiments, slots 803 of a given sidewall 403 may be parallel with each other, running in vertical (up-down) manner, with same, finite, and fixed lengths. See e.g., FIG. 9.

In some embodiments, housing 400 and/or housing 800 may comprise at least one pull-down-assembly 100. In some embodiments, a system (a lighting system) may comprise at least one housing 400 and/or housing 800; and in some embodiments, that system may further comprise at least one pull-down-assembly 100.

FIG. 10 shows a close up (detail) view of a region of FIG. 2A that shows exploded perspective details of one (1) linear-extension-subassembly 109. See FIG. 2A and its above discussion, particularly pertaining to linear-extension-subassembly 109 and portion(s) and/or component(s) thereof.

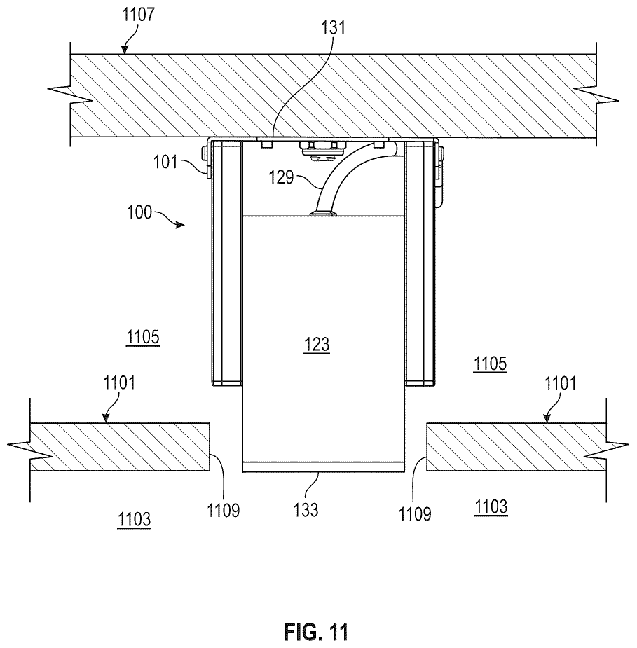

FIG. 11 shows a cross-sectional view of a pull-down-assembly 100 in its retracted configuration with respect to being installed above a ceiling 1101. In some embodiments, ceiling 1101 may be selected from one or more of: ceiling drywall, ceiling sheeting, ceiling sheathing, ceiling members, ceiling tiles, ceiling boards, a false ceiling, a drop-down ceiling, combinations thereof, a portion thereof, and/or the like. Reference numeral “1103” may refer to location(s) below ceiling 1101 (but above a closest below located floor). Reference numeral “1105” may refer to location(s) above ceiling 1101 (but below a next floor or below a roof). In some embodiments, when pull-down-assembly 100 may be in its fully retracted configuration, at least most of pull-down-assembly 100 may reside: above the below-ceiling 1103 region and/or in the above-ceiling 1105 region.

FIG. 11 also shows hole/opening 1109 in ceiling 1101. Hole/opening 1109 may be cut and/or formed in ceiling 1101 such that a diameter of can 123 may pass through hole/opening 1109. Hole/opening 1109 may be cut and/or formed in ceiling 1101 such that a diameter of can 123 may pass through hole/opening 1109 and also wide enough to accommodate passage of (portion(s)) descendable-ascendable-subassemblies 117 through that hole/opening 1109.

FIG. 11 also shows bracket 101 being attached to a structure 1107 located above bracket 101. In some embodiments, structure 1107 may be selected from: top-panel 405, hangar-bar(s), joist(s), stud(s), and/or the like. In FIG. 11, structure 1107 may be at least a portion of: top-panel 405, hangar-bar(s), joist(s), stud(s), and/or the like.

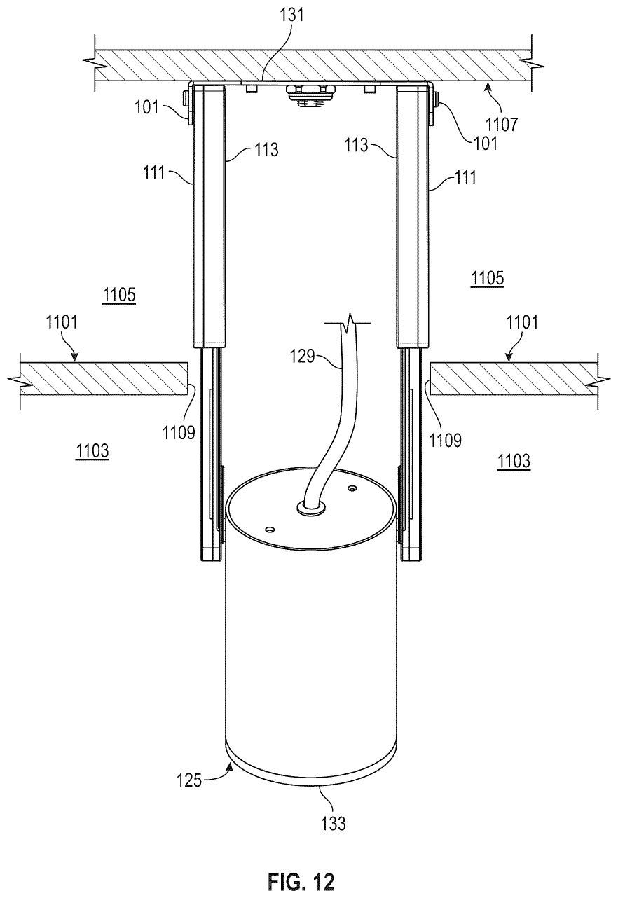

FIG. 12 shows a cross-sectional view of a pull-down-assembly 100 in its extended configuration with respect to being installed above ceiling 1101. FIG. 12 may be the extended configuration of FIG. 11. Pull-down-assembly 100, ceiling 1101, below-ceiling 1103, above-ceiling 1105, structure 1107, and hole/opening 1109 may all be the same in both FIG. 11 and in FIG. 12. In some embodiments, when pull-down-assembly 100 may be in its fully extended configuration, can 123 may reside entirely in the below-ceiling 1103 region and/or entirely below the above-ceiling 1105 region. Although, using stoppage points, can 123 could be partially extended such than an upper portion of can 123 resides in the above-ceiling 1105 region and a bottom portion of can 123 resides in the below-ceiling 1103 region. In some embodiments, when pull-down-assembly 100 may be in its fully extended configuration, a portion of descendable-ascendable-subassembly 117 may reside in the below-ceiling 1103 region and/or below the above-ceiling 1105 region. In some embodiments, when pull-down-assembly 100 may be in its fully extended configuration, a majority of descendable-ascendable-subassembly 117 may reside in the below-ceiling 1103 region and/or below the above-ceiling 1105 region. In some embodiments, when pull-down-assembly 100 may be in its fully extended configuration, a portion (majority) of the descendable-ascendable-subassembly 117 may be extendable out and below the cover 111/113. See e.g., FIG. 12.

Note, housing(s) 400 and/or 800 may also be installed above ceiling 1101 in the same manner and fashion as that of pull-down-assembly 100 in FIG. 11 and in FIG. 12; i.e., replace pull-down-assembly 100 in FIG. 11 and in FIG. 12 with housing 400 and/or 800 such that bottom-main-opening 401 is at a bottom of ceiling 1101.

Note, in some embodiments, trim 125 (members) for bottom communication with lighting-module 200 may be sized from trim MR16 size to trim MR10 size, or a trim size within that range. Note, in some embodiments, trim 125 (members) for bottom communication with lighting-module 200 may be sized from trim MR16 size to trim MR11 size, or a trim size within that range. In some embodiments, the lighting modules (integrated lighting modules) shown and/or described in U.S. utility patent Ser. Nos. 10/914,465, 11/092,326, 11/466,849, and/or 11/668,458; and/or in U.S. patent application Ser. Nos. 19/057,375, 19/020,672, 29/894,010, and/or 29/962,228 may be configured for communication (e.g., direct attachment to) a trim member of a size selected from trim MR16 size to trim MR11 size, or a trim size within that range. In some embodiments, the lighting modules (integrated lighting modules) shown and/or described in U.S. utility patent Ser. Nos. 10/914,465, 11/092,326, 11/466,849, and/or 11/668,458; and/or in U.S. patent application Ser. Nos. 19/057,375, 19/020,672, 29/894,010, and/or 29/962,228 may be configured for communication (e.g., direct attachment to) a trim member of a size selected from trim MR16 size to trim MR10 size, or a trim size within that range.

In some embodiments, pull-down-assembly 100 may be used in various lighting applications. In some embodiments, at least one pull-down-assembly 100, housing 400, and/or housing 800 may be installed within and/or above a ceiling. In some embodiments, at least one pull-down-assembly 100, housing 400, and/or housing 800 may be installed above: ceiling drywall, ceiling sheeting, ceiling sheathing, ceiling members, ceiling tiles, ceiling boards, a false ceiling, a drop-down ceiling, and/or the like. In some embodiments, when at least one pull-down-assembly 100, housing 400, and/or housing 800 may be installed above a ceiling, the can(s) 123 may be extended (pulled) below a bottom plane/surface of that ceiling (e.g., into an extended configuration) or pushed back up to be above that bottom plane/surface of that ceiling (e.g., into a retracted configuration). Further, when in the extended configuration, those extended can(s) 123 may also be rotated (e.g., ninety [90] degrees or less). Thus, a user may adjust where light shines from out of the bottom(s) of such can(s) 123.

In some embodiments, pull-down-assembly 100 may comprise: a bracket 101, at least one linear-extension-subassembly 109, and can 123. In some embodiments, can 123 may be configured to house (enclose, hold, and/or retain) at least most of at least one lighting-module 200 (within can 123). In some embodiments, pull-down-assembly 100 may comprise at least one lighting-module 200. In some embodiments, at least one lighting-module 200 may be at least mostly disposed within can 123. In some embodiments, pull-down-assembly 100 may comprise (at least one) trim 125. In some embodiments, trim 125 may be attached and/or located to/at a bottom of can 123. In some embodiments, trim 125 may be located at a bottom of pull-down-assembly 100. In some embodiments, trim 125 may be located under a bottom of the can 123, forming a bottom of pull-down-assembly 100. See e.g., FIG. 1A and FIG. 2A.

In some embodiments, bracket 101 may be configured to be attached to a structure at a first-region of bracket 101. In some embodiments, this structure is external and separate from pull-down-assembly 100. In some embodiments, the first-region of bracket 101 may be located in between two opposing tabs 102 of bracket 101. In some embodiments, the first-region may comprise at least one or more of: attachment-structure(s) 103, aperture(s) 105, fastener(s) 231, bolt 223, aperture 225, nut 227, and/or plate 229 (see e.g., FIG. 1A, FIG. 1B, FIG. 2A and FIG. 2B). In some embodiments, the first-region of bracket 101 may comprises at least one aperture that passes entirely through a thickness of bracket 101; such as, but not limited to, aperture(s) 105 and/or aperture 225. In some embodiments, when bracket 101 is attached to such a structure, the first-region of bracket 101 may be located below at least some portion of the structure. In some embodiments, the structure may be an enclosure, such as, but not limited to, housing 400 or housing 800 (see e.g., FIG. 4A or FIG. 8). In some embodiments, this external and separate structure may be a hangar-bar (such as, hangar-bar 413), a joist, a stud, and/or a portion of ceiling.

In some embodiments, at least one linear-extension-subassembly 109 may be attached to bracket 101. In some embodiments, the at least one linear-extension-subassembly 109 may be attached to bracket 101 at a second-region of bracket 101. In some embodiments, the second-region is distinct and separated from the first-region (of a given bracket 101). In some embodiments, the second-region may comprise at least one tab 102 of bracket 101. In some embodiments, bracket 101 may comprise the at least one tab 102. In some embodiments, the at least one tab 102 may be configured to be attached to the at least one linear-extension-subassembly 109 (e.g., via through aperture(s) in tab 102 and use of fastener(s) 107). In some embodiments, the at least one tab 102 may be configured to be attached to cover 111/113 (e.g., via through aperture(s) in tab 102 and use of fastener(s) 107). In some embodiments, the at least one linear-extension-subassembly 109 may be attached to bracket 101 at an upper region of the at least one linear-extension-subassembly 109 (such as, at an upper region of cover 111/113). In some embodiments, the at least one linear-extension-subassembly 109 may be attached to bracket 101 at an upper region of cover 111/113. In some embodiments, attachment between bracket 101 and cover 111/113, may be fixed attachment, such that there is no intended movement between bracket 101 and cover 111/113. See e.g., FIG. 1A, FIG. 2A, and FIG. 3A.

In some embodiments, can 123 may be attached to the at least one linear-extension-subassembly 109. In some embodiments, the at least one linear-extension-subassembly 109 is configured to permit movement of can 123 linear straight down or up with respect to bracket 101; and wherein within a full range of that motion/movement, there are a plurality of discreet stopping points where can 123 resists movements that are alternating with points where can 123 is more prone to such movement. In some embodiments, these stopping points are where recessed-portion-engager (raised-bump) 205 physically engages with specific recessed-regions selected from string-of-recessed-portions 203 (of outer-cover 111); and/or where recessed-portion-engager (raised-bump) 215 physically engages with specific recessed-regions selected from string-of-recessed-portions 209 (of first-member 119). See e.g., FIG. 2A, FIG. 2B, FIG. 3A, and FIG. 3B.

In some embodiments, the at least one linear-extension-subassembly 109 may comprise cover 111/113 (outer-cover 111 and inner-cover 113) and descendable-ascendable-subassembly 117. In some embodiments, cover 111/113 may be fixedly attached to bracket 101 (e.g., compare FIG. 1A to FIG. 3A). In some embodiments, descendable-ascendable-subassembly 117 may be at least mostly held within cover 111/113 in a retracted configuration (see e.g., FIG. 1A and/or FIG. 1B). In some embodiments, a portion (a majority) of the descendable-ascendable-subassembly 117 may be slidingly extendable out of and below cover 111/113 in an extended configuration (see e.g., FIG. 3A and/or FIG. 3B). In some embodiments, cover 111/113 may have an opening 135 at a bottom of cover 111/113 for the portion of descendable-ascendable-subassembly 117 to exit cover 111/113 (see e.g., FIG. 3A and/or FIG. 3B). In some embodiments, a region of descendable-ascendable-subassembly 117 always remains within cover 111/113 (even in the extended configuration) (see e.g., FIG. 3A and/or FIG. 3B). In some embodiments, an upper (top) region of descendable-ascendable-subassembly 117 always remains within cover 111/113 (even in the extended configuration) (see e.g., FIG. 3A and/or FIG. 3B).

In some embodiments, descendable-ascendable-subassembly 117 may comprise linkage-arm 213. In some embodiments, linkage-arm 213 may be attached to can 123. In some embodiments, linkage-arm 213 may be attached to can 123 in a manner that facilitates rotation of can 123 with respect to linkage-arm 213. In some embodiments, linkage-arm 213 may be slidable with respect to at least one member of the descendable-ascendable-subassembly 117. In some embodiments, descendable-ascendable-subassembly 117 may comprise this at least one member (e.g., first-member 119 and/or second-member 121). In some embodiments, linkage-arm 213 may be in direct physical communication with the at least one member of descendable-ascendable-subassembly 117. In some embodiments, linkage-arm 213 may always be in direct physical communication with the at least one member of descendable-ascendable-subassembly 117. See e.g., FIG. 2A, FIG. 2B, and FIG. 3B.

In some embodiments, at least one linear-extension-subassembly 109 (of a given pull-down-assembly 100) may be two (2) separate and distinct linear-extension-subassemblies 109. In some embodiments, the two separate and distinct linear-extension-subassemblies (2) may be disposed opposite from each other with can 123 disposed in between the two (2) separate and distinct linear-extension-subassemblies 109. See e.g., FIG. 1A to FIG. 1D.

In some embodiments, can 123 does not physically touch bracket 101 during intended operation of pull-down-assembly 100. See e.g., FIG. 1C and FIG. 3A. However, in theory can 123 could rotated to point at least mostly upwards and then a portion of can 123 might be able to physically contact a circular portion of bracket 101—but such extreme rotation of can 123 would be a non-intended operation of pull-down-assembly 100. For example, and without limiting the scope of the present invention, FIG. 5D shows a can 123 rotated about ninety (90) degrees from vertical and that the rotation can 123 is not physically touching bracket 101. In some embodiments, a can 123 rotation of ninety (90) degrees (from a length of cover 111/113) may be a maximum amount of rotation for the intended operation of pull-down-assembly 100.

Note, no human nor a portion thereof is claimed by any embodiments of the present invention.

A pull-down-assembly (with or without a lighting-module), as well as, a housing (enclosure) for housing (enclosing) pull-down-assemblies, have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A pull-down-assembly for use in lighting applications, wherein the pull-down-assembly comprises:
a bracket that is configured to be attached to a structure at a first-region of the bracket, wherein the structure is external and separate from the pull-down-assembly;
at least one linear-extension-subassembly that is attached to the bracket; and
a can that is attached to the at least one linear-extension-subassembly, wherein the can is configured to house at least most of at least one lighting-module;
wherein the at least one linear-extension-subassembly is configured to permit movement of the can down or up with respect to the bracket.

2. The pull-down-assembly according to claim 1, wherein the first-region of the bracket is located in between two opposing tabs of the bracket.

3. The pull-down-assembly according to claim 1, wherein the first-region of the bracket comprises at least one aperture that passes entirely through a thickness of the bracket.

4. The pull-down-assembly according to claim 1, wherein when the bracket is attached to the structure, the first-region of the bracket is located below at least some portion of the structure.

5. The pull-down-assembly according to claim 1, wherein the structure is an enclosure.

6. The pull-down-assembly according to claim 1, wherein the at least one linear-extension-subassembly is attached to the bracket at a second-region of the bracket, wherein the second-region is distinct and separated from the first-region.

7. The pull-down-assembly according to claim 6, wherein the second-region comprises at least one tab of the bracket, wherein the bracket comprises the at least one tab, wherein the at least one tab is configured to be attached to the at least one linear-extension-subassembly.

8. The pull-down-assembly according to claim 1, wherein the at least one linear-extension-subassembly is attached to the bracket at an upper region of the at least one linear-extension-subassembly.

9. The pull-down-assembly according to claim 1, wherein the at least one linear-extension-subassembly comprises a cover and a descendable-ascendable-subassembly; wherein the cover is fixedly attached to the bracket; wherein the descendable-ascendable-subassembly is at least mostly held within the cover in a retracted configuration; wherein a portion of the descendable-ascendable-subassembly is extendable out and below the cover in an extended configuration.

10. The pull-down-assembly according to claim 9, wherein the cover has an opening at a bottom of the cover for the portion of the descendable-ascendable-subassembly to exit the cover.

11. The pull-down-assembly according to claim 9, wherein a region of the descendable-ascendable-subassembly always remains within the cover.

12. The pull-down-assembly according to claim 9, wherein the descendable-ascendable-subassembly comprises a linkage-arm, wherein the linkage-arm is attached to the can.

13. The pull-down-assembly according to claim 12, wherein the linkage-arm is attached to the can in a manner that facilitates rotation of the can with respect to the linkage-arm.

14. The pull-down-assembly according to claim 12, wherein the linkage-arm is slidable with respect to at least one member of the descendable-ascendable-subassembly, wherein the descendable-ascendable-subassembly comprises the at least one member.

15. The pull-down-assembly according to claim 14, wherein the linkage-arm is in direct physical communication with the at least one member of the descendable-ascendable-subassembly.

16. The pull-down-assembly according to claim 1, wherein the at least one linear-extension-subassembly is two separate and distinct linear-extension-subassemblies.

17. The pull-down-assembly according to claim 16, wherein the two separate and distinct linear-extension-subassemblies are disposed opposite from each other with the can disposed in between the two separate and distinct linear-extension-subassemblies.

18. The pull-down-assembly according to claim 1, wherein the pull-down-assembly comprises the at least one lighting-module, wherein the at least one lighting-module is at least mostly disposed within the can.

19. The pull-down-assembly according to claim 1, wherein the pull-down-assembly comprises a trim; wherein the trim is located under a bottom of the can.

20. The pull-down-assembly according to claim 1, wherein the can does not physically touch the bracket during intended operation of the pull-down-assembly.
